(19) United States
(12) Patent Application Publication
(10) Pub. No.: US 2013/0252292 A1
(43) Pub. Date: Sep. 26, 2013

(54) BIOMASS EXTRACTION PROCESS

(71) Applicant: LIGNOL INNOVATIONS LTD., Burnaby (CA)

(72) Inventors: Alex BERLIN, Burnaby (CA); Mikhail Y. BALAKSHIN, North Vancouver (CA)

(73) Assignee: LIGNOL INNOVATIONS LTD., Burnaby (CA)

(21) Appl. No.: 13/787,565

(22) Filed: Mar. 6, 2013

Related U.S. Application Data
(63) Continuation of application No. PCT/CA2011/001021, filed on Sep. 7, 2011.
(60) Provisional application No. 61/380,675, filed on Sep. 7, 2010.

(51) Int. Cl. C07B 63/02

(52) U.S. Cl. CPC C07B 63/02
USPC 435/135; 562/577; 560/129; 549/490

(57) ABSTRACT

This present invention relates to an organosolv process for the extraction of materials from lignocellulosic biomass. This invention further relates to the chemicals and their derivatives extracted from biomass, uses, apparatus, methods, and the like. In an embodiment of the invention the material extracted from the lignocellulosic biomass is levulinic acid.

This application is a continuation of PCT/CA2011/001021, filed Sep. 7, 2011; which claims the priority of U.S. Provisional Application No. 61/380,675, filed Sep. 7, 2010. The contents of the above-identified applications are incorporated herein by reference in their entireties.

### FIELD

This disclosure relates to an organosolv process for the extraction of materials from lignocellulosic biomass. This disclosure further relates to the chemicals and their derivatives extracted from biomass, uses, apparatus, methods, and the like. In an embodiment the material extracted is levulinic acid.

### BACKGROUND

For environmental, economic, and resource security reasons, there is an increasing desire to obtain energy and material products from bio-renewable resources and particularly from ^{“}waste” and/or non-food biomass feedstocks. The various chemical components within typical biomass can be employed in a variety of ways. In particular, the cellulose and hemicellulose in plant matter may desirably be separated out and fermented into fuel grade alcohol, synthetic biodiesel, fuel grade butanol, xylitol, succinic acid, and other useful materials. And the lignin component, which makes up a significant fraction of species such as trees and agricultural waste, has huge potential as a useful source of aromatic chemicals for numerous industrial applications. To date, most biomass fractionation techniques employed by industry have been optimized for the production of high-quality fibre rather than the production of lignins and their derivatives.

Organosolv processes are well known in the art. See, for example, U.S. Pat. No. 4,100,016; U.S. Pat. No. 4,764,596; U.S. Pat. No. 5,681,427; U.S. Pat. No. 7,465,791; US Patent Application 2009/0118477; US Patent Application 2009/0062516; US Patent Application 2009/00669550; or U.S. Pat. No. 7,649,086. Four major “organosolv” pulping processes have been tested on a trial basis. The first method uses ethanol/water pulping (aka the Lignol® (Alcell®) process); the second method uses alkaline sulphite anthraquinone methanol pulping (aka the “ASAM” process); the third process uses methanol pulping followed by methanol, NaOH, and anthraquinone pulping (aka the “Organocell” process); the fourth process uses acetic acid/hydrochloric acid or formic acid pulping (aka the “Acetosolv” and “Formacell” processes). A description of the Lignol® Alcell® process can be found, for example, in U.S. Pat. No. 4,764,596 or Kendall Pye and Jairo H. Lora, The Alcell™ Process, Tappi Journal, March 1991, pp. 113-117 (the documents are herein incorporated by reference). The process generally comprises pulping or pre-treating a fibrous biomass feedstock with primarily an ethanol/water solvent solution under conditions that include: (a) 60% ethanol/40% water (w/w), (b) a temperature of about 180° C. to about 210° C., and (c) pressure of about 20 atm to about 35 atm. Derivatives of native lignin are fractionated from the biomass into the pulping liquor which also receives solubilised hemicelluloses, other carbohydrates and other components such as resins, phytosterols, terpenes, organic acids, phenols, carbohydrate degradation products and derivatives of these products such as levulinic acid, formic acid, 5-hydromethyl furfural (5-HMF), furfural, and tannins. Organosolv pulping liquors comprising the fractionated derivatives of native lignin and other components from the fibrous biomass feedstocks, are often called “black liquors”. Various disclosures exemplified by U.S. Pat. No. 7,465,791 and PCT Patent Application Publication No. WO 2007/129921, describe modifications to the Lignol® Alcell® organosolv.

Organosolv processes, particularly the Lignol® Alcell® process, can be used to separate highly purified lignin derivatives and other useful materials from biomass. Such processes may therefore be used to exploit the potential value of the various components making up the biomass.

Despite these advantages, organosolv processes have to date met with limited commercial success. This may be due to a variety of reasons such as, for example, the fact that organosolv extraction typically involves higher pressures than other industrial methods and are thus more complex and energy intensive. Moreover, organosolv extraction processes can result in the production of self-precipitated lignins or lignins with poor solubility in the cooking liquor (SPLs), particularly when using softwood biomass but also when other types of biomass are used. SPLs can attach to metal surfaces causing equipment to be fouled and are difficult to remove. Furthermore, the necessity of restricting operating conditions to those which produce a fermentable carbohydrate stream or a high quality fibre has limited the type and utility of the lignin stream. Consequently, although large scale commercial viability was demonstrated many years ago from a technical and operational perspective, organosolv biomass extraction has not, to date, been widely adopted.

Due to toxicity, regulatory, renewability or supply security issues many manufacturers of chemical products are seeking alternatives to their current technologies. For example, formaldehyde-based resins such as phenol formaldehyde (PF), urea formaldehyde and melamine formaldehyde are extremely common and used for a variety of purposes such as manufacturing of housing and furniture panels such as medium density fibreboard (MDF), oriented strand board (OSB), plywood, and particleboard. Concerns about the toxicity of formaldehyde have led regulatory authorities to mandate a reduction of formaldehyde emissions (e.g. California Environmental Protection Agency Airborne Toxic Control Measure (ATCM) to Reduce Formaldehyde Emissions from Composite Wood Products, Apr. 26, 2007). It has been proposed to use lignin-cellulosic materials in PF resins (see, for example, U.S. Pat. No. 5,173,527).

However, large-scale commercial application of the extracted lignin derivatives, particularly those isolated in traditional pulping processes employed in the manufacture of pulp and paper, has been limited due to, for example, the inconsistency of their chemical and functional properties. This inconsistency can be due to changes in feedstock supplies or the particular extraction/generation/recovery conditions required to keep the fibre quality in accordance with market demands. These issues are further complicated by the variety of the molecular structures of lignin derivatives produced by the various extraction methods and the difficulty in performing reliable routine analyses of the structural conformity and integrity of recovered lignin derivatives.

### SUMMARY OF THE INVENTION

The present disclosure provides a process for the extraction of materials from lignocellulosic biomass. Such materials may include lignin derivatives as well as process-derived bioaromatic molecules (PBMs) which can be defined as ensembles of organic molecules, primarily aromatic in nature, which are derived from biomass. Non-limiting examples of PBMs are products of condensation between furan derivatives and levulinic acids, phenol or phenol-like monomers or oligomers with ethanol, furan, and levulinates or formiates, and others.

An embodiment of the present process comprises treating a lignocellulosic biomass in the presence of a solvent and under conditions suitable to form a slurry. The process separates at least a part of the aromatic compounds from the biomass, such aromatic compounds being useful for a variety of industrial purposes.

The present disclosure further provides a jacketed pressure reactor equipped with or without mechanical mixing for extraction of materials from a lignocellulosic biomass.

The present disclosure further provides certain compounds that may be extracted from lignocellulosic by means of the present process.

The present disclosure further provides certain uses of compounds that may be extracted from lignocellulosic by means of the present process.

The present disclosure further provides methods for improving the yield of valuable chemicals produced as the result of a biomass extraction process.

As used herein, the term “biorefining” refers to the production of bio-based products (e.g. lignin derivatives) from biomass.

As used herein, the term “organosolv” refers to bio-refinery processes wherein the biomass is subject to an extraction step using an organic solvent at an elevated temperature.

As used herein, the term “native lignin” refers to lignin in its natural state, in plant material.

As used herein, the terms “lignin derivatives” and “derivatives of native lignin” refer to lignin material extracted from lignocellulosic biomass. Usually, such material will be a mixture of chemical compounds that are generated during the extraction process.

This summary does not necessarily describe all features of the invention. Other aspects, features and advantages of the invention will be apparent to those of ordinary skill in the art upon review of the following description of specific embodiments of the invention.

### BRIEF DESCRIPTION OF THE DRAWINGS

FIG. 1 shows a typical Lignol® lignin (Alcell®) organosolv process;

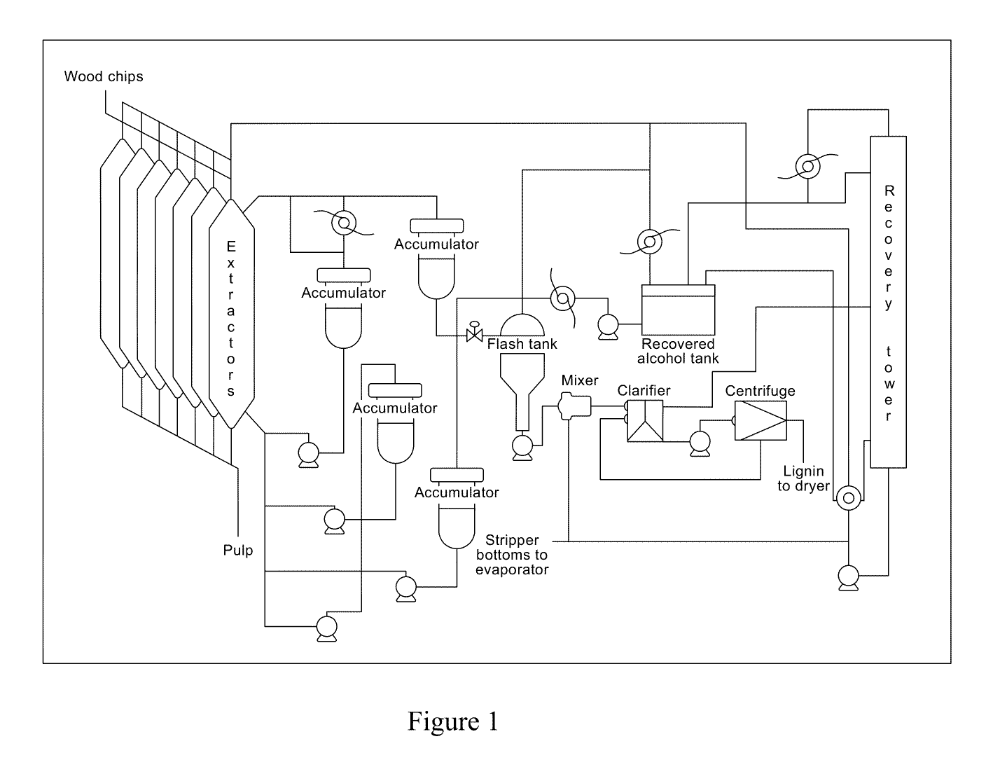

FIG. 2 shows a flow diagram of an embodiment of the present process;

FIGS. 3 shows crude oil remediation with MAC-I and MAC-II;

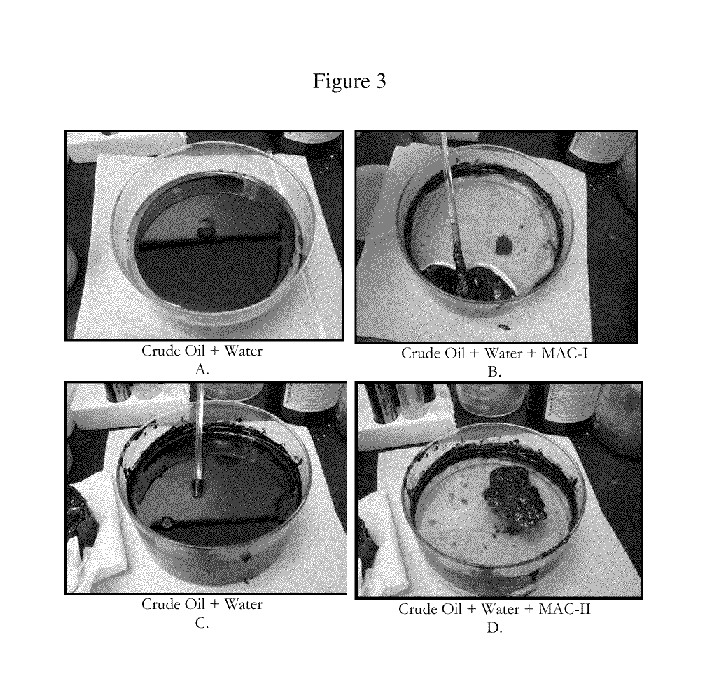

FIG. 4 shows GC-MS Analysis of the FILTRATE (Agilent 7000B GC-MS);

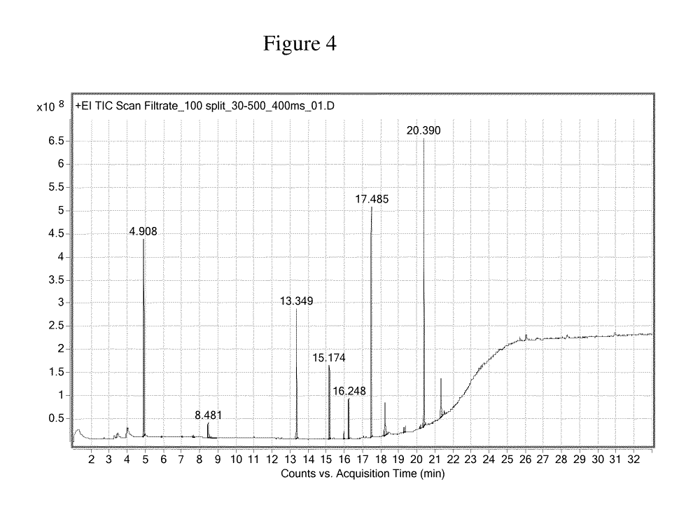

FIG. 5 shows LC/QTOF Analysis of the FILTRATE (ES+TOF, SB-CN Column);

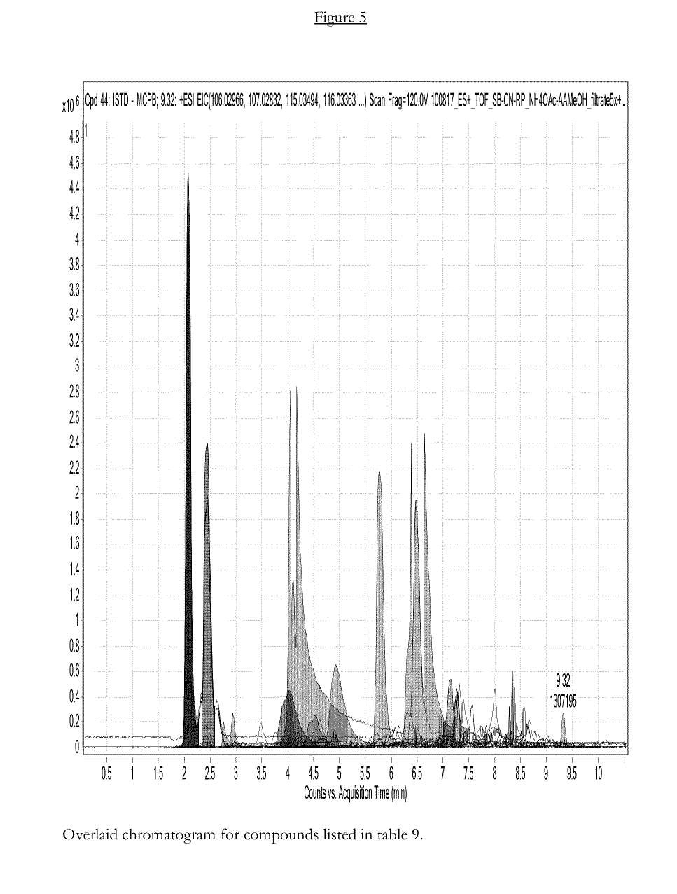

FIG. 6 shows an overlaid chromatogram for compounds listed in Table 10;

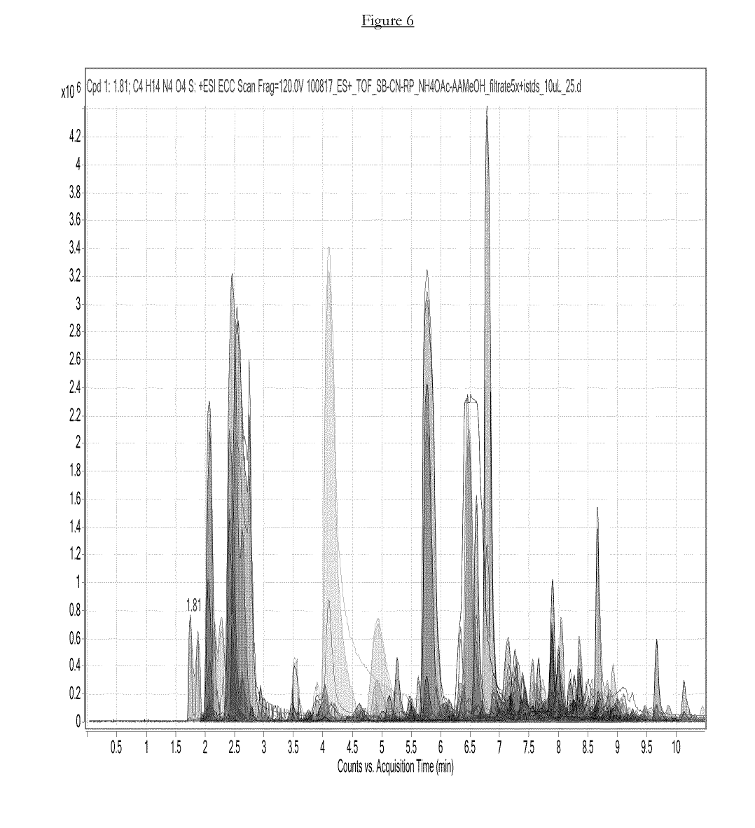

FIG. 7 shows ¹³C quantitative NMR of the CONCENTRATE from aspen;

FIG. 8 shows ¹³C quantitative NMR of the PURIFIED MAC-I from aspen;

FIG. 9 shows ¹³C Quantitative NMR of the MAC-II from aspen.

### DETAILED DESCRIPTION

The present disclosure provides an extraction process. The present disclosure provides a process for the extraction of materials from lignocellulosic biomass. Such materials include lignin derivatives as well as other process-derived bioaromatic materials (PBMs) which can be defined as ensembles of organic molecules, primarily aromatic in nature, which are derived from biomass (e.g. mixes of aromatic compounds (MACs)). These materials may be useful as potential to replacements for one or more than one petrochemical in industrial chemical products and may also potentially be used to enhance the performance of the end-chemical products. Examples of PBMs include the products of condensation between furan derivatives and levulinic acids, phenol or phenol-like monomers or oligomers with ethanol, furan, and levulinates or formiates, and others. The present disclosure further provides a method of producing levulinic acid with a certain yield. The present disclosure further provides a method of making ethyl levulinate via a biomass extraction process.

The present process comprises mixing an organic solvent with a lignocellulosic biomass under such conditions that a slurry is formed. As used herein, the term “slurry” refers to particles of biomass at least temporarily suspended in a solvent.

In one embodiment the present process comprises:
(a) placing a lignocellulosic material in an extraction vessel;
(b) mixing the lignocellulosic material with an organic solvent to form an extraction mixture;
(c) subjecting the mixture to a temperature and pressure such that a slurry is formed;
(d) maintaining the elevated temperature and pressure for a period;
(e) recovering aromatic compounds from the solvent.

It has been found that the present process produces high yields of precipitable compounds suitable for a range of applications. The slurries produced in the present process are easy to pump and filter in order to separate the precipitable substances from the insoluble material. Typical organosolv processes involve liquids/solids separation of fibrous biomass material and spent liquor or liquid stream after the pretreatment stage, washing of the fibrous solids, circulation of pretreatment liquor through a heat exchanger, and flashing of the spent liquor. The present process requires none of these steps although a flashing step may optionally be included. In addition, the present process can be run with the help of mechanical mixing which facilitates heat and mass transfer and allows for faster reaction rates and higher yields. The mechanical mixing is not generally started at the beginning of the process but once the biomass has been partially slurried to avoid excessive energy consumption that would otherwise be needed to achieve mixing.

In one embodiment the present process comprises:
(a) placing a lignocellulosic material in an extraction vessel;
(b) mixing the lignocellulosic material with an organic solvent and an acid catalyst to form an extraction mixture;
(c) subjecting the mixture to a temperature and pressure such that a slurry is formed;
(d) maintaining the elevated temperature and pressure for a period;
(e) separating at least part of the liquid potion of the slurry from the insoluble portion;
(f) recovering aromatic compounds from the solvent.

The extraction mixture slurry herein preferably has a viscosity of 1500 cps or less, 1000 cps or less, 800 cps or less, 600 cps or less, 400 cps or less, 200 cps or less, 100 cps or less (viscosity measurements made using viscometer Viscolite 700 (Hydramotion Ltd., Malton, York YO17 6YA England).

The present extraction mixture preferably is subjected to pressures of about 1 bar or greater, about 5 bar or greater, about 10 bar or greater, about 15 bar or greater, about 18 bar or greater. For example, about 19 bar, about 20 bar, about 21 bar, about 22 bar, about 23 bar, about 24 bar, about 25 bar, about 26 bar, about 27 bar, about 28 bar, about 29 bar, or greater.

The present extraction mixture preferably is subjected to temperatures of from about 150° C. or greater, about 160° C. or greater, about 170° C. or greater, about 180° C. or greater, about 190° C. or greater, about 200° C. or greater, about 210° C. or greater.

The present extraction mixture preferably is subjected to the elevated temperature for about 5 minutes or more, about 10 minutes or more, about 15 minutes or more, about 20 minutes or more, about 25 minutes or more, about 30 minutes or more, about 35 minutes or more, about 40 minutes or more, about 45 minutes or more, about 50 minutes or more, about 55 minutes or more, about 60 minutes or more, about 65 minutes or more.

The present extraction mixture preferably is subjected to the elevated temperature for about 300 minutes or less, about 270 minutes or less, about 240 minutes or less, about 210 minutes or less, about 180 minutes or less, about 150 minutes or less, about 120 minutes or less.

For example, the present extraction mixture can be subjected to the elevated temperature for about 30 to about 100 minutes.

The present extraction mixture preferably comprise about 40% or more, about 42% or more, about 44% or more, about 46% or more, about 48% or more, about 50% or more, about 52% or more, about 54% or more, organic solvent such as ethanol.

The present extraction mixture preferably comprises about 80% or less, about 70% or less, about 68% or less, about 66% or less, about 64% or less, about 62% or less, about 60% or less, organic solvent such as ethanol.

For example, the present extraction mixture may comprise about 45% to about 65%, about 50% to about 60% organic solvent such as ethanol.

The present extraction mixture preferably has a pH of about 1.0 or greater, about 1.2 or greater, about 1.4 or greater, about 1.6 or greater, about 1.8 or greater. The present extraction mixture preferably has a pH of from about 3 or lower, about 2.8 or lower, about 2.6 or lower, about 2.4 or lower, about 2.2 or lower. For example, the extraction mixture may have a pH of from about 1.5 to about 2.5. For example, from about 1.6 to about 2.3.

The pH of the extraction mixture may be adjusted by any suitable means. For example, from about 0.1% or greater, about 0.2% or greater, about 0.3% or greater, about 0.4% or greater, by weight, of acid may be added to the extraction mixture. From about 5% or lower, about 4% or lower, about 3% or lower, by weight, of acid (based on dry weight wood) may be added to the biomass. The starting pH of the extraction mixture is the pH of the mixture of the extraction solution after it has been incubated with the biomass for a few minutes. Some biomass species, such as corn stover, are basic and can partially neutralize the acid while some biomass species are acidic and can further lower the pH.

The weight ratio of solvent to biomass in the present extraction mixture may be from about 10:1 to about 4:1, about 9:1 to about 4.5:1, about 8:1 to about 5:1, from about 7:1 to about 5.5:1. For example the ratio may be about 6:1.

The present organic solvent may be selected from any suitable solvent. For example, aromatic alcohols such as phenol, catechol, and combinations thereof; short chain primary and secondary alcohols, such as methanol, ethanol, propanol, and combinations thereof. For example, the solvent may be a mix of ethanol & water. The solvent mix might be preheated before being added to the extraction vessel.

The present biomass may optionally be subjected to several solvent washes prior to or even after the aforementioned extraction process. For example, such washes may be under milder process conditions than the above extraction process. These solvent washes may be used to remove useful compounds from the biomass and/or to imbue the compounds that result from the organosolv extraction process with certain properties. These additional solvent washes may utilize any suitable solvent such as, for example, water, acetone, tetrahydrofuran, methyl ethyl ketone, ethyl acetate, acetonitrile, dimethyl sulphoxide, hexane, diethyl ether, methylene chloride, carbon tetrachloride, formic acid, acetic acid, formamide, benzene, methanol, ethanol, propanol, butanol, catechol, or mixtures thereof.

Any suitable lignocellulosic biomass may be utilized herein including hardwoods, softwoods, annual fibres, energy crops, municipal waste, and combinations thereof.

Hardwood feedstocks include Acacia; Afzelia; Synsepalum duloificum; Albizia; Alder (e.g. Alnus glutinosa, Alnus rubra); Applewood; Arbutus; Ash (e.g. F. nigra, F. quadrangulata, F. excelsior, F. pennsylvanica lanceolata, F. latifolia, F. profunda, F. americana); Aspen (e.g. P. grandidentata, P. tremula, P. tremuloides); Australian Red Cedar (Toona ciliata); Ayna (Distemonanthus benthamianus); Balsa (Ochroma pyramidale); Basswood (e.g. T. americana, T. heterophyllal); Beech (e.g. F. sylvatica, F. grandifolia); Birch; (e.g. Betula populifolia, B. nigra, B. papyrifera, B. lenta, B. alleghaniensis/B. lutea, B. pendula, B. pubescens); Blackbean; Blackwood; Bocote; Boxelder; Boxwood; Brazilwood; Bubinga; Buckeye (e.g. Aesculus hippocastanum, Aesculus glabra, Aesculus flava/Aesculus octandra); Butternut; Catalpa; Cherry (e.g. Prunus serotina, Prunus pennsylvanica, Prunus avium); Crabwood; Chestnut; Coachwood; Cocobolo; Corkwood; Cottonwood (e.g. Populus balsamifera, Populus deltoides, Populus sargentii, Populus heterophylla); Cucumbertree; Dogwood (e.g. Cornus florida, Cornus nuttallii); Ebony (e.g. Diospyros kurzii, Diospyros melanida, Diospyros crassiflora); Elm (e.g. Ulmus americana, Ulmus procera, Ulmus thomasii, Ulmus rubra, Ulmus glabra); Eucalyptus; Greenheart; Grenadilla; Gum (e.g. Nyssa sylvatica, Eucalyptus globulus, Liquidambar styraciflua, Nyssa aquatica); Hickory (e.g. Carya alba, Carya glabra, Carya ovata, Carya laciniosa); Hornbeam; Hophornbeam; Ipê; Iroko; Ironwood (e.g. Bangkirai, Carpinus caroliniana, Casuarina equisetifolia, Choricbangarpia subargentea, Copaifera spp., Eusideroxylon zwageri, Guajacum officinale, Guajacum sanctum, Hopea odorata, Ipe, Krugiodendron ferreum, Lyonothamnus lyonii (L. floribundus), Mesua ferrea, Olea spp., Olneya tesota, Ostrya virginiana, Parrotia persica, Tabebuia serratifolia); Jacarand\acute{;}Jotoba; Lacewood; Laurel; Limba; Lignum vitae; Locust (e.g. Robinia pseudacacia, Gleditsia triacanthos); Mahogany; Maple (e.g. Acer saccharum, Acer nigrum, Acer negundo, Acer rubrum, Acer saccharinum, Acer pseudoplatanus); Meranti; Mpingo; Oak (e.g. Quercus macrocarpa, Quercus alba, Quercus stellata, Quercus bicolor, Quercus virginiana, Quercus michauxii, Quercus prinus, Quercus muhlenbergii, Quercus chrysolepis, Quercus lyrata, Quercus robur, Quercus petraea, Quercus rubra, Quercus velutina, Quercus laurifolia, Quercus falcata, Quercus nigra, Quercus phellos, Quercus texana); Obeche; Okoumé; Oregon Myrtle; California Bay Laurel; Pear; Poplar (e.g. P. balsamifera, P. nigra, Hybrid Poplar (Populus×canadensi)); Ramin; Red cedar; Rosewood; Sal; Sandalwood; Sassafras; Satinwood; Silky Oak; Silver Wattle; Snakewood; Sourwood; Spanish cedar; American sycamore; Teak; Walnut (e.g. Juglans nigra, Juglans regia); Willow (e.g. Salix nigra, Salix alba); Yellow poplar (Liriodendron tulipifera); Bamboo; Palmwood; and combinations/hybrids thereof.

For example, hardwood feedstocks for the present invention may be selected from Acacia, Aspen, Beech, Eucalyptus, Maple, Birch, Gum, Oak, Poplar, and combinations/hybrids thereof. The hardwood feedstocks for the present invention may be selected from Populus spp. (e.g. Populus tremuloides), Eucalyptus spp. (e.g. Eucalyptus globulus), Acacia spp. (e.g. Acacia dealbata), and combinations/hybrids thereof.

Softwood feedstocks include Araucaria (e.g. A. cunninghamii, A. angustifolia, A. araucana); softwood Cedar (e.g. Juniperus virginiana, Thuja plicata, Thuja occidentalis, Chamaecyparis thyoides Callitropsis nootkatensis); Cypress (e.g. Chamaecyparis, Cupressus Taxodium, Cupressus arizonica, Taxodium distichum, Chamaecyparis obtusa, Chamaecyparis lawsoniana, Cupressus semperviren); Rocky Mountain Douglas fir; European Yew; Fir (e.g. Abies balsamea, Abies alba, Abies procera, Abies amabilis); Hemlock (e.g. Tsuga canadensis, Tsuga mertensiana, Tsuga heterophylla); Kauri; Kaya; Larch (e.g. Larix decidua, Larix kaempferi, Larix laricina, Larix occidentalis); Pine (e.g. Pinus nigra, Pinus banksiana, Pinus contorta, Pinus radiata, Pinus ponderosa, Pinus resinosa, Pinus sylvestris, Pinus strobus, Pinus monticola, Pinus lambertiana, Pinus taeda, Pinus palustris, Pinus rigida, Pinus echinata); Redwood; Rimu; Spruce (e.g. Picea abies, Picea mariana, Picea rubens, Picea sitchensis, Picea glauca); Sugi; and combinations/hybrids thereof.

For example, softwood feedstocks which may be used herein include cedar; fir; pine; spruce; and combinations/hybrids thereof. The softwood feedstocks for the present invention may be selected from loblolly pine (Pinus taeda), radiata pine, jack pine, spruce (e.g., white, interior, black), Douglas fir, Pinus silvestris, Picea abies, and combinations/hybrids thereof. The softwood feedstocks for the present invention may be selected from pine (e.g. Pinus radiata, Pinus taeda); spruce; and combinations/hybrids thereof.

Annual fibre feedstocks include biomass derived from annual plants, plants which complete their growth in one growing season and therefore must be planted yearly. Examples of annual fibres include: flax, cereal straw (wheat, barley, oats), sugarcane bagasse, rice straw, corn stover, corn cobs, hemp, fruit pulp, alfalfa grass, esparto grass, switchgrass, and combinations/hybrids thereof. Industrial residues like corn cobs, fruit peals, seeds, etc. may also be considered annual fibres since they are commonly derived from annual fibre biomass such as edible crops and fruits. For example, the annual fibre feedstock may be selected from wheat straw, corn stover, corn cobs, sugar cane bagasse, and combinations/hybrids thereof.

Typical organosolv processes can be very sensitive to biomass quality requiring higher quality feedstocks and avoiding certain feedstocks which result in fouling of the apparatus. The present process seems have a reduced sensitivity and thus does not suffer from the same restrictions in terms of biomass and may allow for processing low value biomass residues such as sawdust, tree needles, hog fuel, bark, newspaper, fruit peels, rice hulls, and low quality wood chips among others.

The liquid portion of the extraction mixture may be separated from the solid portion by any suitable means. For example, the slurry may be passed through an appropriately sized filter, centrifugation followed by decanting or pumping of the supernatant, tangential ultrafiltration, evaporation alone or solvent extraction followed by evaporation, among others.

The aromatic compounds may be recovered from the liquid portion of the extraction mixture by any suitable means. For example, the solvent may be evaporated to precipitate the compounds. The compounds in the spent liquor can be recovered chromatographically followed by recrystallization or precipitation, dilution of the spent liquor with acidified water followed by filtration, centrifugation or tangential filtration, liquid/liquid extraction, among others.

The present aromatic compounds may be recovered in a single step or may be recovered in stages to provide compounds having different properties. The precipitated aromatic compounds do not seem to be sticky and are generally easy to filter.

The present compounds may be recovered for the extraction mixture by quenching the cooked mixture. For example, cold water may be added to the mixture in a ratio of 2 or more to 1 (H₂0 to extraction mixture).

The present disclosure provides a process of producing PBMs in high yields. For example, the present disclosure can provide yields of PBMs (MAC-I, MAC-II) greater than the theorectical maximum of lignin in the biomass feedstock material as calculated on a weight percentage. The present yield of PBMs may be about 90%, about 95%, about 100%, about 105%, about 110%, about 115%, or greater, of the theoretical maximum yield of lignin in the biomass. That is, the yield of PBMs is approaching or greater than that of the theoretical maximum yield of lignin. The yield of PBMs and the theoretical maximum yield of lignin may be calculated by methods well known to the person of skill in the art.

The present disclosure provides lignin derivatives which have advantageous z-average molecular weights. While not wishing to be bound by theory it is believed that the present aromatic compounds having low z-average molecular weight (Mz) give surprisingly good properties when formulated in phenol formaldehyde resins. The present disclosure provides lignin derivative having a Mz of about 3500 or less, about 3000 or less, about 2750 or less, about 2500 or less.

The present disclosure provides lignin derivatives having a number average molecular weight (Mn) of about 3000 or less, about 2000 or less, about 1000 or less, about 900 or less, about 800 or less, about 700 or less, about 600 or less.

The present disclosure provides lignin derivatives having a weight average molecular weight (Mw) of about 2000 or less, about 1800 or less, about 1600 or less, about 1400 or less, about 1300 or less.

The present aromatic compounds may be used for a variety of applications such as, for example, phenol formaldehyde resins, phenol furan resins, in particular foundry resins, urea formaldehyde resins, epoxy resins, other resol or novolac resins, other resins, environmental remediation of hydrocarbon spills, remediation of other contamination, waste water treatment for recycling or reclaiming, antioxidants, wax emulsions, carbon fibers, surfactants, coatings, among others.

The present aromatic compounds may be used as precursors for furan-phenolic foundry resins or other furan resins. In foundry resins furfuryl alcohol is used in the synthesis of furan resins and the present aromatic compounds could replace phenol and/or some of the furfuryl alcohol or the resin precursor itself synthesized by reacting phenol with furfuryl alcohol.

The present dissolved or slurried biomass contains extractives, carbohydrates, modified phenolic compounds, modified carbohydrates, carbohydrate & lignin degradation products, ethyl levulinate, and/or ethyl formiate etc. This mixture may be concentrated off the filtrate, for example, by evaporation during the solvent recovery process or after the solvent recovery process (after distilling off the solvent) producing a concentrate. Ethyl levulinate can be recovered by vacuum distillation since its boiling point is 93-94° C./18 mmHg. The distilled product can be useful for cosmetic applications or as a raw material for chemical reactions including conversion into a biofuel such as methylTHF or can be used as is as a fuel oxygenating agent, it can also be used in the synthesis of renewable polymers such as biodegradable ketals.

The present disclosure provides a method of producing high yields of levulinic acid, ethyl levulinate or other esters. For example, after biomass extraction unreacted levulinic acid and ethanol is present in significant quantities in the acidified water-diluted spent liquor. The stoichiometric yield of levulinic acid may be about 10 or greater, about 20% or greater, about 30% or greater, about 40% or greater, about 50% or greater, about 60% or greater, about 70% or greater. These substances may be reacted, for example, with a commercial esterase such as Novozym 435® (Novozymes North America Inc., Franklinton, N.C., USA) to produce ethyl levulinate. The esterase may be immobilised and therefore easy to recycle. The reaction is relatively fast (60-120 min) and can be run at 50-70° C. and atmospheric pressure. The pH of the diluted spent liquor can be adjusted for optimal enzyme performance. By operating at relatively low temperatures (50-70° C.), by-product formation can be kept to a minimum, reducing downstream purifications costs. Moreover if one would prefer not to distill the ethanol in the diluted spent liquor but to recover it in form of ethyl levulinate, one could add more levulinic acid to the diluted spent liquor (enrich it) and with the help of the esterase (e.g. Novozym 435®) convert ethanol and levulinic acid to ethyl levulinate. Ethyl levulinate is a more valuable product than ethanol. Other commercial enzymes may be used for this purpose including, for instance, Lipase QML6, Resinase HT, Lipozyme RM IM, Lipex 100L, Lipozyme TL IM or combinations thereof. Experimental esterases may be used such as those produced by fungal or bacterial strains e.g. Bacillus subtilis, Trichoderma reesei, Penicillium funiculosum, Aspergillus niger, Chrysosporium lucknowense, Candida antarctica, Rhizomucor miehei, Thermomyces lanuginosa, among others. For this purpose, one would preferentially use esterases or lipases showing esterase activity and tolerant to the presence of ethanol in the concentrations typical for water-diluted spent liquors (>10% wt.).

The stoichiometric yield of levulinic acid (LVAC) from the cellulosic fraction of wood can be calculated from the relative molecular weights of the components in the following manner:

$$\% stoich . yield = \frac{\begin{matrix}Maximum \# mols of LVAC from 1 mol of glucose \times \\ Mol . Wt . of LVAC\end{matrix}}{Molecular weight of glucose in units in cellulose} = \frac{1 mol \text{/} mol \times 116 gm \text{/} mol}{164 gm glucose \text{/} mol cellulose} = 70.7 \%$$

Previously observed LVAC yields from in Organolsolv production methods were less than 2% of theoretical. Even dedicated, non-Organosolv LVAC production processes project up to 40% of theoretical. The yields seen in this process are substantially above what was expected.

Another useful product present in the spent liquor is diphenolic acid which is currently considered a viable non-harmful substitute of the estrogenic bisphenol A (BPA) commonly used in manufacturing plastics. The concentrate or the filtrate before concentrating it can then be processed, for instance, by anaerobic digestion into biogas be burnt for energy production. The calorific value of the solids in this concentrate can be greater than 10,000 BTU/Lb solids according to oxygen calorimetric analysis. Alternatively, the concentrate can be used as a raw material for production of valuable fine or specialty chemicals. A range of valuables chemicals such as ethyl levulinates, ethyl formiates, levulinic acid, furfural, furfural derivatives and others have been detected in the concentrate.

The present disclosure provides for a lower temperature pre-organosolv stage that can be incorporated in the process so that valuable extractives are isolated from biomass before running the process under more severe liquefying conditions. For instance, when processing softwoods rosin acids and terpenoids can be produced at this stage by extraction with benzene or other alternative solvents. Pre-extraction can be particularly attractive when biorefining tree bark, leaves and needles. This pre-organosolv stage is particularly efficient when processing low quality feedstocks such as sawdust or tree needles and it can be run with the same solvent used in the biomass organosolv stage or with a different solvent depending on the targeted compounds to be extracted from the biomass.

The present disclosure provides an extraction vessel. The vessel preferably has a means for causing the circulation of the extraction mixture/slurry such as an internal mixing element and/or combined with injected steam. The vessel preferably has a means for causing the extraction mixture/slurry to be heated such as a heating jacket. The extraction vessel is preferably a jacketed pressure reactor. A jacketed pressure reactor has not been used for organosolv extraction due to its unsuitability for traditional organosolv processes. However, the ability to use off-the-shelf technology for organosolv extraction reduces the technical and commercial hurdles facing the adoption of the technology.

This present process may be deployed in a high pressure jacketed industrial chemical reactor made of an alloy resistant to hot acid such as Hastelloy® B® (registered trademark of Haynes International and it refers to nickel-molybdenum corrosion-resistant alloys) or Inconal® (registered trademark of Special Metals Corporation and it refers to a family of austenitic nickel-chromium-based superalloys) or in other high pressure steel reactors, such as stainless steel 316L, coated by Teflon® or other acid-resistant coatings or protected by electrochemical corrosion mitigation methods such as anodic and cathodic protection systems supplied by companies such as Corrosion Service (Markham, ON, Canada). The process can be deployed, for instance, in a readily available 250 gal Hastelloy B reactor or in a 3,000 gal scale Inconal reactor or in larger ones located in a fine chemicals facility.

The present process does not require several of the apparatus that is usually required in organosolv processes such as Accumulators, Recirculation Pumps & Heaters, Pulp Washers, and Specialized Flow-Thru Digesters which represents a considerable capital saving.

It is contemplated that any embodiment discussed in this specification can be implemented or combined with respect to any other embodiment, method, composition or aspect of the invention, and vice versa.

All citations are herein incorporated by reference, as if each individual publication was specifically and individually indicated to be incorporated by reference herein and as though it were fully set forth herein. Citation of references herein is not to be construed nor considered as an admission that such references are prior art to the present invention.

The invention includes all embodiments, modifications and variations substantially as hereinbefore described and with reference to the examples and figures. It will be apparent to persons skilled in the art that a number of variations and modifications can be made without departing from the scope of the invention as defined in the claims. Examples of such modifications include the substitution of known equivalents for any aspect of the invention in order to achieve the same result in substantially the same way.

The present invention will be further illustrated in the following examples. However it is to be understood that these examples are for illustrative purposes only, and should not be used to limit the scope of the present invention in any manner.

### EXAMPLES

### Example 1

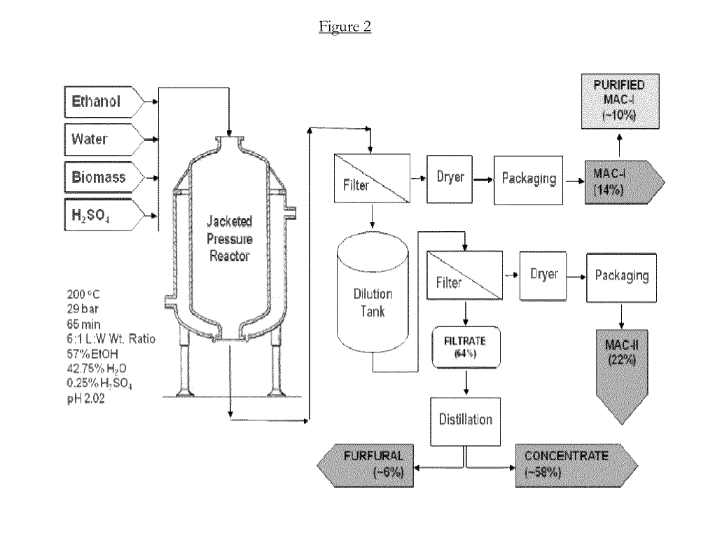

An extraction was performed according to the system of FIG. 2. 700 g of aspen (Populus tremuloides) chips were added to a 8-L 316L stainless steel jacketed pressure reactor (Parr Instrument Company, Moline, Ill., USA). 4200 g of solvent (57% ethanol, 42.75% tap H₂0 and 0.25% H₂SO₄) was added to the chips to give an extraction mixture having a 6:1 solvent to wood weight ratio. The pH of the mixture was 2.02.

The mixture was heated with hot oil circulated thru a jacket to a temperature of 200° C. The pressure inside the reactor was 29 bar. A low viscosity slurry was formed. The slurry was dischargeable by gravity thru a bottom discharge valve. The mixture was not stirred. The heating was maintained for 65 minutes.

After heating the extraction mixture was drained and filtered with a coarse paper filter. The solids recovered by filtration were air-dried, manually milled and stored in a sealed container. The yield of this first aromatic product (MAC-I) was about 14% of the total dry weight biomass processed. The filtered extraction liquid (spent liquor) was then diluted with acidified water (˜pH 2.0) at 4:1 weight water to spent liquor ratio causing the second mix of aromatic products (MAC-II) to precipitate. The precipitate was recovered by filtration similarly to MAC-I, air-dried and stored. The yield of MAC-II was about 22%. The total yield of recovered MACs was about 36%. The ethanol was recovered by rotary evaporation of the filtrate liquid yielding a 2× concentrated solution. This last step performed in a rectification column would be more efficient and would yield ˜1.2× concentrate.

Results

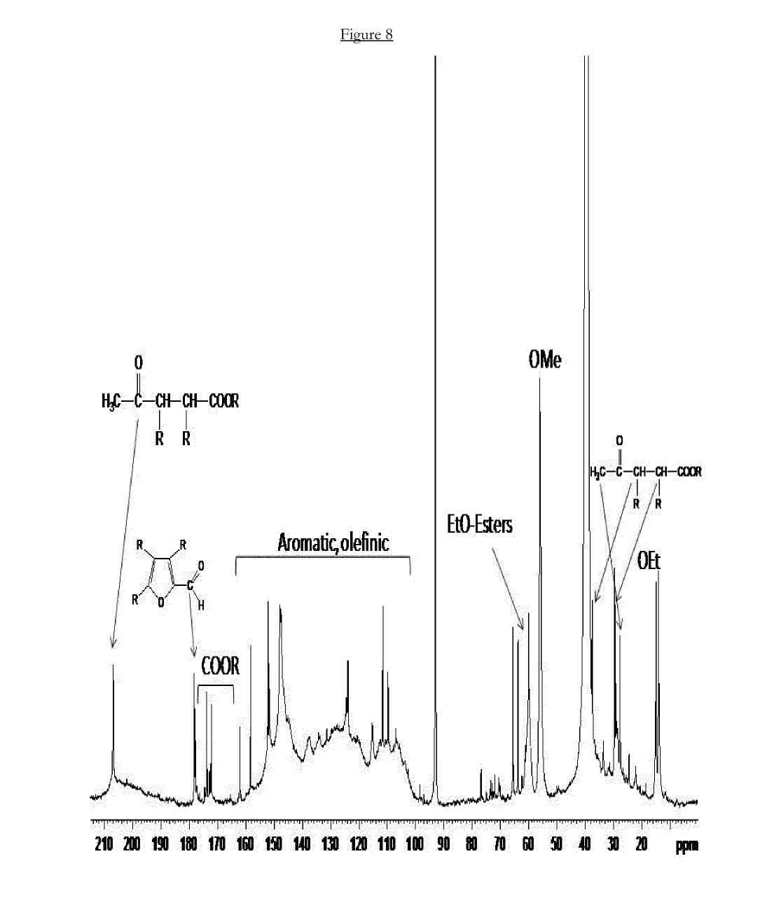

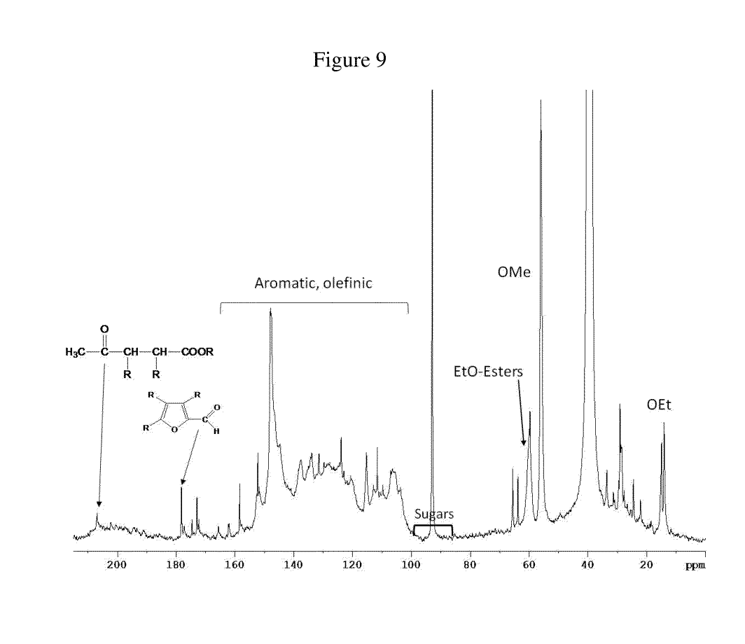

The aromatic compounds (MACs/PBMs) show lower average molecular weights (Mn), lower amounts of various oxygenated aliphatic structures (ethers and aliphatic hydroxyls) and lower S/G ratio than Alcell® lignins. 2D HSQC NMR analysis (not shown) and quantitative ¹³C NMR spectra (FIGS. 8 and 9) show incorporation of furfural and levulinic acid derivatives into MACs. Furfural, 5-ethoxymethyl furfural, ethyl levulinate, ethyl formiate and levulinic acid seem to be produced by the present process as the main products of carbohydrate degradation.

TABLE 1
Chemical Characteristics of Aspen MAC-I, Aspen MAC-II, and Purified Aspen MAC-I compared to Alcell ® Lignin

| | Product Yield | Lignin Content | CO_nc | CO_conj | CO_tot | OH_pr | OH_sec | OH_al | OH_ph | OH_tot |
|---|---|---|---|---|---|---|---|---|---|---|
| | % on wood | % | mmol/g | | | | | | | |
| MAC I | 14.0 | 69.7 | N/A | N/A | N/A | N/A | N/A | N/A | N/A | N/A |
| MAC II | 22.0 | 95.4 | 1.33 | 1.24 | 2.58 | 0.75 | nd | 0.75 | 4.63 | 5.38 |
| PURIFIED MAC I | 10.0 | 91.4 | 1.70 | 1.02 | 2.73 | 1.14 | nd | 1.14 | 2.91 | 4.05 |
| ALCELL ® Lignin | 14.0 | 97.0 | 0.93 | 0.58 | 1.51 | 1.35 | 1.09 | 2.44 | 4.68 | 7.12 |

| | | | | | | | |
|---|---|---|---|---|---|---|---|
| COOR_al | COOR_con | COOR_tot | OMe | OEt | S | G | H |

| | |
|---|---|
| mmol/g | SG_Ratio |

| | | | | | | | | | |
|---|---|---|---|---|---|---|---|---|---|
| MAC I | N/A | N/A | N/A | N/A | N/A | N/A | N/A | N/A | N/A |
| MAC II | 0.94 | 0.13 | 1.06 | 4.34 | 0.59 | 1.84 | 2.94 | 0.63 | 0.63 |
| PURIFIED MAC I | 0.91 | 0.09 | 1.00 | 2.99 | 0.68 | 1.00 | 1.64 | 0.55 | 0.61 |
| ALCELL ® Lignin | 1.03 | 0.19 | 1.22 | 6.44 | 0.42 | 2.79 | 2.31 | 0.38 | 1.21 |

| | BETA_5 | BETA_BETA | BETA_O_4 | DC | Mn | Mw | Mz | | Ash |
|---|---|---|---|---|---|---|---|---|---|
| | mmol/g | | | % | g/mol | | | D | % |
| MAC I | N/A | N/A | N/A | N/A | 343 | 2883 | 5906 | 8.40 | 3.35 |
| MAC II | 0.00 | 0.03 | 0.00 | 54 | 599 | 1329 | 2379 | 2.22 | 0.10 |
| PURIFIED MAC I | 0.00 | 0.02 | 0.00 | 71 | 281 | 2644 | 5562 | 9.38 | 0.10 |
| ALCELL ® Lignin | 0.19 | 0.19 | 0.45 | 43 | 863 | 1908 | 3906 | 2.22 | 0.06 |

TABLE 2
Carbohydrate, Ash, and Acid-Insoluble Solids (AIS), and Acid-Soluble Solids (ASS) in MACs and their fractions

| | Percent Content on Dry Basis | | | | | | | |
|---|---|---|---|---|---|---|---|---|
| Biomass Fraction | Arabinan | Galactan | Glucan | Xylan | Mannan | AIS* | ASS** | Ash |
| ACETONE-PURIFIED MAC I | 0.01 | 0.01 | 1.45 | 0 | 0.07 | 90.84 | 0.55 | 0.21 |
| ACETONE-INSOLUBLES MAC-I | 0.05 | 0.05 | 65.92 | 0.09 | 0.03 | 21.26 | 0.4 | 10.92 |
| MAC I | 0.02 | 0.01 | 19.47 | 0.01 | 0.09 | 72.46 | 0.62 | 3.34 |
| MAC II | 0 | 0 | 0.23 | 0 | 0.01 | 92.93 | 2.46 | 0 |

*AIS—Acid-Insoluble Solids (Mostly Aromatic Compounds);
**ASS—Acid-Soluble Solids (Mostly Aromatic Compounds

TABLE 3
Elemental Analysis of Aspen MACs

| | C | H | N | S | O* |
|---|---|---|---|---|---|
| | % Content by wt. | | | | |
| MAC-I* | 61.72 | 4.81 | 0.16 | 1.80 | 31.51 |
| ACETONE-INSOLUBLES | 44.87 ± 0.55 | 4.80 ± 0.06 | 0.10 ± 0.01 | 2.93 ± 0.04 | 47.30 |
| MAC-I | | | | | |
| ACETONE-SOLUBLES | 68.94 ± 0.01 | 4.81 ± 0.03 | 0.18 ± 0.01 | 1.31 ± 0.03 | 24.76 |
| MAC-I | | | | | |
| MAC-II | 69.09 ± 0.02 | 4.90 ± 0.54 | 0.16 ± 0.01 | 0.62 ± 0.01 | 25.23 |

*Calculated values

### 1) The FILTRATE and CONCENTRATE

The FILTRATE is the solution obtained after filtration of the precipitated MAC II. The MAC II is precipitated from the black liquor containing slurried biomass by dilution with acidified water. Surprisingly, very low concentration of carbohydrates was observed in the FILTRATE (Table 4) indicating that carbohydrates were degraded during the present process. However, significant concentrations of useful chemicals, such as levulinic acid derivatives and furfural, were detected in the FILTRATE.

Recovery of ethanol from the FILTRATE was achieved after evaporation of about one half of the solution when the process is run in a rotary evaporator. Under these conditions, volatile components, such as furfural, 5-HMF, partially acetic and formic acids, will be also evaporated to a greater or lesser degree depending on distillation conditions. About 25% of the organic compounds in the FILTRATE seems to be volatile.

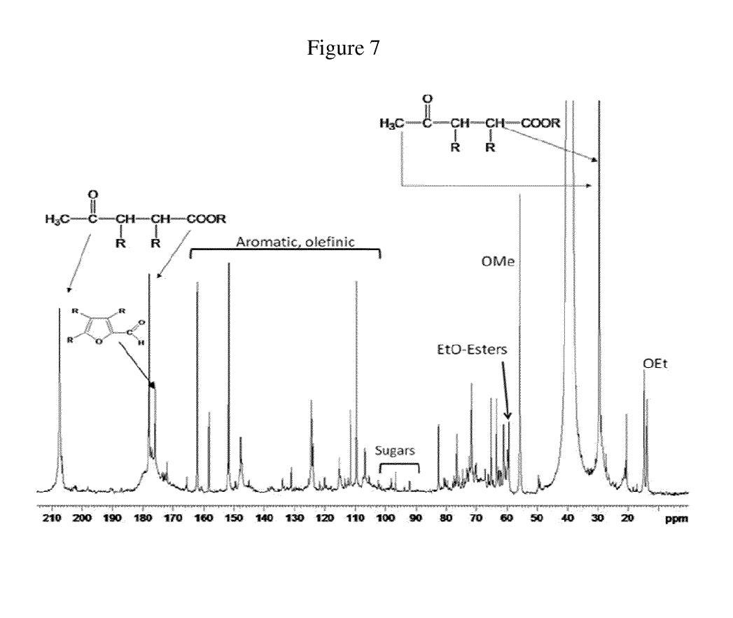

For analytical purposes, the FILTRATE was evaporated to dryness and the resulting re-dissolved CONCENTRATE was analysed by high resolution NMR techniques (FIG. 7, Table 6). The major components of the CONCENTRATE are derivatives of levulinic acid and furfural derivatives (5-HMF). A significant number of reaction products were ethylated, either as ethers or esters. As expected from the FILTRATE HPLC analysis (Table 4), the amount of carbohydrates observed in the NMR spectra was rather low. Significant amounts of carbohydrates are apparently converted to hydroxy- and saccharinic acids.

TABLE 4
Chemical Composition of the FILTRATE

| Average | STDEV | CV (%) | Average | STDEV | CV (%) | Average | STDEV | CV (%) | Average | STDEV | CV (%) | Average | STDEV | CV (%) |
|---|---|---|---|---|---|---|---|---|---|---|---|---|---|---|
| HMF (g/L) | | | Furfural (g/L) | | | Acetic Acid (g/L) | | | Levulinic acid (g/L) | | | Lactic Acid (g/L) | | |
| 0.61 | 0.01 | 2.28 | 2.11 | 0.03 | 1.29 | 1.02 | 0.00 | 0.28 | 1.53 | 0.00 | 0.24 | 0.15 | 0.00 | 2.63 |
| Arabinose (g/L) | | | Galactose (g/L) | | | Glucose (g/L) | | | Mannose (g/L) | | | Xylose (g/L) | | |
| 0 | 0 | 0 | 0 | 0 | 0 | 0.98 | 0.02 | 2.32 | 0.04 | 0.00 | 1.37 | 0 | 0 | 0 |

TABLE 5
Chemical Composition of the CONCENTRATE

| Average | STDEV | CV (%) | Average | STDEV | CV (%) | Average | STDEV | CV (%) | Average | STDEV | CV (%) | Average | STDEV | CV (%) |
|---|---|---|---|---|---|---|---|---|---|---|---|---|---|---|
| HMF (g/L) | | | Furfural (g/L) | | | Acetic Acid (g/L) | | | Levulinic acid (g/L) | | | Lactic Acid (g/L) | | |
| 1.19 | 0.02 | 1.30 | 0.18 | 0.00 | 1.07 | 1.49 | 0.00 | 0.25 | 2.80 | 0.01 | 0.26 | 0.27 | 0.01 | 2.51 |
| Arabinose (g/L) | | | Galactose (g/L) | | | Glucose (g/L) | | | Mannose (g/L) | | | Xylose (g/L) | | |
| 0 | 0 | 0 | 0 | 0 | 0 | 1.82 | 0.04 | 2.34 | 0.07 | 0.00 | 4.82 | 0 | 0 | 0 |

TABLE 6
NMR analysis of the CONCENTRATE. Distribution of carbon atoms of various types (% of total carbon)

| | | COOR—_al + | | Aromatic + | Oxygenated | OMe | Saturated | | |
|---|---|---|---|---|---|---|---|---|---|
| CO_nc | CO_conj | furfur.der. | COOR_con. | aliphatic | aliphatic¹ | (+HMF) | aliphatic² | EtO— | Total |
| 9.00 | 1.62 | 15.00 | 0.63 | 25.01 | 18.02 | 3.83 | 20.03 | 6.86 | 100 |

¹carbon with aliphatic hydroxyl and ether type
²CH₃—, CH₂—and CH—(not oxygenated)

TABLE 7
Integration Peak List GC-MS Analysis of the FILTRATE

| | | | Area | Confirmed | |
|---|---|---|---|---|---|
| Peak | RT | Area | % | ID* | Library Match** |
| 1 | 4.908 | 1135152972 | 20.7 | Ethanol | |
| 2 | 5.892 | 5327648 | 0.10 | | Methyl Acetate |
| 3 | 7.029 | 6922947 | 0.13 | | 1,1-Dimethoxy |
| | | | | | ethane |
| 4 | 7.654 | 13323996 | 0.24 | | Ethyl Acetate |
| 5 | 8.481 | 112719972 | 2.1 | Acetic Acid | |
| 6 | 13.349 | 655761415 | 12.0 | Furaldehyde | |
| 7 | 15.174 | 353738837 | 6.5 | | substitued Furan |
| 8 | 15.976 | 37371490 | 0.68 | | substitued Furan |
| 9 | 16.248 | 194903728 | 3.6 | | poor match |
| 10 | 17.485 | 1074126495 | 19.6 | | likely Ethyl |
| | | | | | Levuinate |
| 11 | 18.243 | 209840574 | 3.8 | Levulinic | |
| | | | | Acid | |
| 12 | 19.285 | 22227732 | 0.41 | | Levoglusenone |
| 13 | 19.360 | 24382265 | 0.45 | | poor match |
| 14 | 20.207 | 15143646 | 0.28 | | substitued Furan |
| 15 | 20.390 | 1396888395 | 25.5 | | 5-Ethoxymethyl |
| | | | | | Furfural |
| 16 | 21.337 | 219302450 | 4.0 | 5- | |
| | | | | Hydoxymethyl | |
| | | | | Furfural | |

Notes:
*Confirmed by retention time and spectral matching with pure compound
**NIST library used for all compounds except WILEY library used for peak #15

TABLE 8
Semi-quantitative concentration of confirmed by
GC-MS compounds in the FILTRATE

| | Concentration in | |
|---|---|---|
| Compound | Filtrate | Units |
| Ethanol | 13.5 | % (v/v) |
| Acetic Acid | 0.52 | % (v/v) |
| Furaldehyde | 1.8 | % (v/v) |
| Levulinic | 1.1 | % (v/v) |
| Acid | | |
| 5-HMF | 0.55 | % (m/v) |
| Vanillin | 0.03 | % (m/v) |

TABLE 9
Formulas for suggested compounds searched against acquired data on LC/QTOF of the FILTRATE.

| | | | | | | | Diff (Tgt, | Score |
|---|---|---|---|---|---|---|---|---|
| Cpd | Name | RT | Formula (Tgt) | Height | Area | Mass | ppm) | (Tgt) |
| 1 | Glyceric Acid | 1.86 | C3H6O4 | 11,321 | 50,602 | 106.0262 | −3.8 | 46.9 |
| 2 | D-Glucuronic Acid | 1.86 | C6H10O7 | 18,921 | 48,205 | 194.0426 | −0.3 | 47.6 |
| 3 | D-Gluconic Acid | 1.92 | C6H12O7 | 22,961 | 122,346 | 196.0582 | −0.6 | 61.0 |
| 5 | 2-Hydroxypropionic | 2.08 | C3H6O3 | 4,128,421 | 27,556,200 | 90.0316 | −1.0 | 99.8 |
| 6 | Lactic Acid | 2.08 | C3H6O3 | 4,128,421 | 27,556,200 | 90.0316 | −1.0 | 99.8 |
| 7 | Mannose | 2.08 | C6H12O6 | 4,539,014 | 29,783,073 | 180.0633 | −0.5 | 99.8 |
| 8 | Galactose | 2.08 | C6H12O6 | 4,539,014 | 29,783,073 | 180.0633 | −0.5 | 99.8 |
| 9 | Glucose | 2.08 | C6H12O6 | 4,539,014 | 29,783,073 | 180.0633 | −0.5 | 99.8 |
| 10 | Acetic Acid | 2.08 | C2H4O2 | 4,087,666 | 26,852,460 | 60.0210 | −1.6 | 99.8 |
| 14 | D-Arabinonic Acid | 2.25 | C5H10O6 | 19,262 | 245,755 | 166.0474 | −1.8 | 47.3 |
| 15 | Xylitol (Other Sugar Alcohols) | 2.26 | C5H12O5 | 21,798 | 120,856 | 152.0687 | 1.7 | 81.9 |
| 16 | Diethyl Ester Hydroxy butanedioic | 2.45 | C6H10O5 | 2,400,216 | 20,488,667 | 162.0530 | 1.3 | 98.3 |
| 17 | 1,6-anhydroglucose | 2.45 | C6H10O5 | 2,400,216 | 20,488,667 | 162.0530 | 1.3 | 98.3 |
| 18 | Ethyl Ester 2-Furancarboxylic acid | 2.76 | C7H8O3 | 198,069 | 1,027,049 | 140.0472 | −0.8 | 97.6 |
| 19 | Ethyl Methyl Ester Butanedioic acid | 2.94 | C7H12O4 | 259,217 | 1,249,775 | 160.0735 | −0.2 | 86.7 |
| 20 | 2-Hydroxy-3-methyl-2-cyclopenten-1-one | 3.01 | C6H8O2 | 27,165 | 134,204 | 112.0527 | 2.1 | 77.8 |
| 22 | Methyl Furfural (Furfural Derivatives) | 4.03 | C6H6O2 | 444,363 | 10,009,028 | 110.0371 | 2.6 | 99.3 |
| 23 | 5-Methyl-2-furancarboxaldehyde | 4.03 | C6H6O2 | 444,363 | 10,009,028 | 110.0371 | 2.6 | 99.3 |
| 24 | Ethyl Lactate | 4.04 | C5H10O3 | 381,392 | 3,471,968 | 118.0631 | 1.2 | 98.8 |
| 25 | ISTD - Dicamba | 4.05 | C8H6Cl2O3 | 103,733 | 631,772 | 219.9688 | −2.5 | 96.6 |
| 26 | 5-Hydroxymethylfurfural | 4.18 | C6H6O3 | 2,812,068 | 50,578,798 | 126.0318 | 0.5 | 99.7 |
| 27 | p-Hydroxybenzoic Acid | 4.36 | C7H6O3 | 57,933 | 702,997 | 138.0313 | −3.1 | 86.6 |
| 28 | Furfural | 4.54 | C5H4O2 | 251,552 | 4,055,605 | 96.0215 | 3.4 | 99.1 |
| 29 | Ethyl Ester 2-Hydroxy butanoic acid | 4.62 | C6H12O3 | 69,593 | 709,947 | 132.0787 | 0.1 | 99.4 |
| 30 | 2-Methoxy phenol | 4.92 | C7H8O2 | 652,893 | 13,420,475 | 124.0525 | 0.3 | 99.8 |
| 33 | Ethyl Levulinate | 5.77 | C7H12O3 | 2,165,364 | 20,705,326 | 144.0781 | −3.5 | 98.3 |
| 35 | 2,6-Dimethoxy Phenol (Syringol) | 6.64 | C8H10O3 | 2,454,849 | 50,498,178 | 154.0627 | −1.6 | 81.7 |
| 36 | Isoeugenol (2-methoxy-4-propenyl) phenol | 6.66 | C10H12O2 | 26,483 | 185,183 | 164.0832 | −3.1 | 67.0 |
| 39 | Syringaldehyde | 7.15 | C9H10O4 | 531,113 | 4,786,853 | 182.0577 | −1.1 | 99.2 |
| 40 | Succinic Acid | 7.26 | C4H6O4 | 8,655 | 45,958 | 118.0269 | 2.2 | 84.2 |
| 41 | ISTD - 2,4-DP | 7.62 | C9H8Cl2O3 | 59,499 | 301,263 | 233.9849 | −0.5 | 99.1 |
| 44 | ISTD - MCPB | 9.32 | C11H13ClO3 | 269,397 | 1,307,195 | 228.0543 | −4.3 | 86.4 |

TABLE 10
Formulas resulting from Molecular Feature Extraction and Molecular Formula Generator.
MS-mode, positive ion, using SB-CN column and LC/QTOF.

| | | | | | | Diff | |
|---|---|---|---|---|---|---|---|
| | | | | Mass | | (MFG, | Score |
| Cpd | RT | Height | Mass | (MFG) | Formula (MFG) | ppm) | (MFG) |
| 1 | 1.81 | 667632 | 214.0739 | 214.0736 | C4H14N4O4S | −1.4 | 80.6 |
| 2 | 1.96 | 45021 | 183.0384 | 183.0388 | C5H13NO2S2 | 1.9 | 47.0 |
| 3 | 1.96 | 23845 | 199.0160 | 199.0159 | C5H13NOS3 | −0.5 | 47.6 |
| 10 | 2.06 | 859938 | 218.0192 | 218.0190 | C15H6S | −0.8 | 75.9 |
| 11 | 2.07 | 2046818 | 202.0447 | 202.0451 | C4H6N6O4 | 1.7 | 94.3 |
| 12 | 2.08 | 375893 | 382.1091 | 382.1084 | C10H18N6O10 | −1.7 | 92.4 |
| 13 | 2.08 | 35777 | 184.0347 | 184.0347 | C12H8S | −0.4 | 47.6 |
| 14 | 2.09 | 1465486 | 197.0900 | 197.0899 | C6H15NO6 | −0.2 | 47.5 |
| 15 | 2.09 | 145433 | 162.0525 | 162.0528 | C6H10O5 | 1.9 | 86.4 |
| 17 | 2.24 | 647979 | 242.1050 | 242.1049 | C6H18N4O4S | −0.4 | 85.4 |
| 18 | 2.39 | 17546 | 114.0319 | 114.0317 | C5H6O3 | −1.9 | 47.4 |
| 20 | 2.42 | 1312362 | 208.0944 | 208.0947 | C8H16O6 | 1.4 | 74.1 |
| 21 | 2.43 | 1422495 | 162.0527 | 162.0528 | C6H10O5 | 0.6 | 80.0 |
| 24 | 2.45 | 464169 | 482.2293 | 482.2298 | C20H38N2O9S | 1.0 | 81.1 |
| 25 | 2.45 | 18811 | 435.1664 | 435.1657 | C29H25NOS | −1.7 | 46.8 |
| 26 | 2.45 | 903515 | 230.0768 | 230.0764 | C6H10N6O4 | −2.0 | 81.3 |
| 27 | 2.46 | 895524 | 438.1721 | 438.1710 | C14H26N6O10 | −2.4 | 88.7 |
| 28 | 2.46 | 107771 | 446.1578 | 446.1577 | C23H26O9 | −0.2 | 75.9 |
| 31 | 2.47 | 2292217 | 225.1211 | 225.1212 | C8H19NO6 | 0.7 | 94.7 |
| 32 | 2.55 | 45418 | 172.0731 | 172.0736 | C8H12O4 | 2.6 | 46.6 |
| 33 | 2.6 | 1845952 | 116.0476 | 116.0473 | C5H8O3 | −2.4 | 88.0 |
| 35 | 2.75 | 33302 | 386.0889 | 386.0892 | C14H26O6S3 | 0.6 | 47.6 |
| 36 | 2.76 | 200852 | 139.0632 | 139.0633 | C7H9NO2 | 1.0 | 87.7 |
| 37 | 2.79 | 20763 | 128.0473 | 128.0473 | C6H8O3 | 0.2 | 47.6 |
| 39 | 2.79 | 95316 | 382.1740 | 382.1740 | C18H26N2O7 | 0.0 | 84.0 |
| 40 | 2.79 | 88559 | 184.0732 | 184.0736 | C9H12O4 | 1.8 | 47.0 |
| 41 | 2.95 | 240808 | 142.0631 | 142.0630 | C7H10O3 | −0.5 | 47.6 |
| 42 | 3 | 147823 | 352.1637 | 352.1634 | C17H24N2O6 | −0.8 | 84.5 |
| 43 | 3.02 | 36344 | 130.0631 | 130.0630 | C6H10O3 | −0.9 | 47.2 |
| 44 | 3.26 | 46909 | 146.0575 | 146.0579 | C6H10O4 | 2.6 | 47.0 |
| 45 | 3.38 | 12453 | 102.0317 | 102.0317 | C4H6O3 | −0.4 | 47.2 |
| 46 | 3.48 | 125369 | 253.1526 | 253.1525 | C10H23NO6 | −0.4 | 86.5 |
| 47 | 3.51 | 88350 | 346.1378 | 346.1376 | C14H22N2O8 | −0.7 | 85.0 |
| 48 | 3.53 | 361865 | 190.0839 | 190.0841 | C8H14O5 | 1.0 | 86.6 |
| 49 | 3.75 | 67235 | 253.1529 | 253.1525 | C10H23NO6 | −1.3 | 84.5 |
| 50 | 3.97 | 147917 | 190.0840 | 190.0841 | C8H14O5 | 0.6 | 85.9 |
| 51 | 3.98 | 50719 | 172.0733 | 172.0736 | C8H12O4 | 1.8 | 47.4 |
| 53 | 4.03 | 233108 | 253.1529 | 253.1525 | C10H23NO6 | −1.4 | 83.0 |
| 55 | 4.05 | 14681 | 221.9667 | 221.9665 | C7H10S4 | −0.8 | 47.1 |
| 56 | 4.06 | 121416 | 236.1265 | 236.1269 | C11H24OS2 | 1.6 | 45.8 |
| 57 | 4.12 | 42500 | 444.1351 | 444.1355 | C22H24N2O6S | 0.9 | 72.1 |
| 58 | 4.12 | 2156399 | 126.0318 | 126.0317 | C6H6O3 | −0.5 | 99.4 |
| 59 | 4.2 | 106857 | 114.0682 | 114.0681 | C6H10O2 | −0.8 | 47.4 |
| 60 | 4.44 | 28142 | 156.0785 | 156.0786 | C8H12O3 | 1.2 | 47.4 |
| 62 | 4.61 | 31824 | 202.0837 | 202.0841 | C9H14O5 | 2.1 | 46.3 |
| 63 | 4.62 | 80491 | 142.0627 | 142.0630 | C7H10O3 | 1.8 | 47.2 |
| 66 | 4.91 | 118051 | 140.0472 | 140.0473 | C7H8O3 | 0.9 | 47.5 |
| 67 | 4.94 | 257983 | 246.1368 | 246.1368 | C14H18N2O2 | 0.0 | 86.1 |
| 68 | 4.95 | 636096 | 123.0684 | 123.0684 | C7H9NO | 0.3 | 87.9 |
| 69 | 5.02 | 64528 | 374.1691 | 374.1689 | C16H26N2O8 | −0.4 | 83.5 |
| 70 | 5.13 | 161387 | 156.0786 | 156.0786 | C8H12O3 | 0.4 | 87.2 |
| 72 | 5.25 | 15961 | 206.1150 | 206.1154 | C9H18O5 | 2.0 | 46.3 |
| 73 | 5.27 | 302915 | 170.0941 | 170.0943 | C9H14O3 | 1.4 | 79.2 |
| 75 | 5.51 | 96651 | 224.0681 | 224.0685 | C11H12O5 | 1.5 | 86.6 |
| 76 | 5.55 | 69074 | 264.1124 | 264.1123 | C14H12N6 | −0.3 | 86.5 |
| 79 | 5.63 | 275465 | 208.0733 | 208.0736 | C11H12O4 | 1.1 | 96.8 |
| 80 | 5.76 | 277398 | 374.1692 | 374.1689 | C16H26N2O8 | −0.8 | 67.4 |
| 81 | 5.77 | 91178 | 333.1425 | 333.1424 | C14H23NO8 | −0.4 | 83.4 |
| 83 | 5.78 | 2063231 | 144.0783 | 144.0786 | C7H12O3 | 2.7 | 94.4 |
| 84 | 5.79 | 2260283 | 98.0370 | 98.0368 | C5H6O2 | −2.0 | 99.2 |
| 85 | 5.86 | 70292 | 176.1043 | 176.1049 | C8H16O4 | 2.9 | 75.3 |
| 86 | 5.89 | 81710 | 292.1061 | 292.1059 | C14H16N2O5 | −0.7 | 86.0 |
| 87 | 5.89 | 100465 | 203.0581 | 203.0582 | C11H9NO3 | 0.6 | 47.5 |
| 88 | 5.93 | 240159 | 190.0838 | 190.0841 | C8H14O5 | 1.8 | 83.5 |
| 89 | 5.98 | 33072 | 214.1201 | 214.1205 | C11H18O4 | 2.1 | 46.0 |
| 90 | 5.98 | 14485 | 214.0840 | 214.0841 | C10H14O5 | 0.8 | 47.4 |
| 91 | 6.07 | 99753 | 200.1045 | 200.1049 | C10H16O4 | 1.9 | 84.8 |
| 92 | 6.08 | 65770 | 218.1154 | 218.1154 | C10H18O5 | 0.0 | 47.0 |
| 94 | 6.12 | 44199 | 188.1043 | 188.1049 | C9H16O4 | 3.0 | 46.2 |
| 95 | 6.15 | 141468 | 142.0630 | 142.0630 | C7H10O3 | 0.1 | 47.6 |
| 96 | 6.18 | 77101 | 184.1099 | 184.1099 | C10H16O3 | 0.0 | 86.8 |
| 98 | 6.26 | 102662 | 264.1473 | 264.1474 | C14H20N2O3 | 0.5 | 86.7 |
| 101 | 6.35 | 246774 | 266.1264 | 266.1267 | C13H18N2O4 | 0.8 | 79.0 |
| 104 | 6.39 | 16420 | 236.0680 | 236.0685 | C12H12O5 | 2.0 | 47.6 |
| 105 | 6.39 | 38784 | 188.1043 | 188.1049 | C9H16O4 | 2.7 | 47.0 |
| 107 | 6.46 | 2003564 | 168.0782 | 168.0786 | C9H12O3 | 2.9 | 82.9 |
| 125 | 6.49 | 1794382 | 108.0212 | 108.0211 | C6H4O2 | −1.0 | 87.2 |
| 126 | 6.49 | 1851472 | 171.0894 | 171.0895 | C8H13NO3 | 0.9 | 93.6 |
| 131 | 6.51 | 82397 | 151.0994 | 151.0997 | C9H13NO | 2.0 | 47.1 |
| 132 | 6.6 | 73136 | 200.1046 | 200.1049 | C10H16O4 | 1.3 | 78.8 |
| 133 | 6.61 | 678120 | 180.0783 | 180.0786 | C10H12O3 | 1.8 | 81.6 |
| 136 | 6.63 | 84897 | 215.0940 | 215.0946 | C13H13NO2 | 2.7 | 46.1 |
| 137 | 6.63 | 112734 | 188.1043 | 188.1049 | C9H16O4 | 2.9 | 86.8 |
| 138 | 6.64 | 114439 | 209.1048 | 209.1052 | C11H15NO3 | 2.0 | 46.9 |
| 140 | 6.68 | 54699 | 170.0575 | 170.0579 | C8H10O4 | 2.4 | 46.6 |
| 142 | 6.72 | 79975 | 229.0734 | 229.0739 | C13H11NO3 | 2.0 | 85.4 |
| 144 | 6.8 | 2267396 | 210.0889 | 210.0892 | C11H14O4 | 1.4 | 96.1 |
| 146 | 6.9 | 89431 | 194.0575 | 194.0579 | C10H10O4 | 2.1 | 86.3 |
| 147 | 6.9 | 56959 | 188.1043 | 188.1049 | C9H16O4 | 2.8 | 46.1 |
| 148 | 6.91 | 74982 | 282.1211 | 282.1216 | C13H18N2O5 | 1.8 | 82.4 |
| 149 | 6.91 | 160260 | 224.0682 | 224.0685 | C11H12O5 | 1.2 | 86.5 |
| 151 | 6.97 | 46660 | 268.0946 | 268.0947 | C13H16O6 | 0.5 | 69.8 |
| 152 | 6.99 | 21815 | 340.1649 | 340.1648 | C17H20N6O2 | −0.4 | 46.7 |
| 154 | 7 | 96334 | 222.0889 | 222.0892 | C12H14O4 | 1.4 | 66.9 |
| 156 | 7.07 | 23382 | 280.0951 | 280.0954 | C7H16N6O4S | 0.9 | 47.1 |
| 157 | 7.09 | 33682 | 224.1049 | 224.1049 | C12H16O4 | −0.4 | 47.1 |
| 158 | 7.09 | 27798 | 220.0739 | 220.0736 | C12H12O4 | −1.3 | 47.0 |
| 159 | 7.14 | 78389 | 240.0998 | 240.0998 | C12H16O5 | −0.3 | 47.6 |
| 160 | 7.14 | 18953 | 200.0683 | 200.0685 | C9H12O5 | 0.9 | 46.9 |
| 161 | 7.15 | 37545 | 256.1310 | 256.1318 | C6H20N6O3S | 2.8 | 47.4 |
| 162 | 7.15 | 52307 | 314.1841 | 314.1842 | C15H26N2O5 | 0.3 | 80.0 |
| 163 | 7.16 | 135614 | 168.0419 | 168.0423 | C8H8O4 | 2.1 | 47.3 |
| 164 | 7.17 | 512388 | 182.0577 | 182.0579 | C9H10O4 | 1.3 | 90.0 |
| 165 | 7.18 | 262272 | 180.0782 | 180.0786 | C10H12O3 | 2.5 | 85.7 |
| 167 | 7.18 | 26272 | 282.1108 | 282.1110 | C7H18N6O4S | 0.9 | 46.5 |
| 168 | 7.19 | 34152 | 112.0523 | 112.0524 | C6H8O2 | 0.9 | 47.6 |
| 169 | 7.2 | 89287 | 156.0782 | 156.0786 | C8H12O3 | 2.7 | 86.3 |
| 170 | 7.2 | 102326 | 268.0948 | 268.0954 | C6H16N6O4S | 2.1 | 60.7 |
| 171 | 7.2 | 54538 | 326.1476 | 326.1478 | C15H22N2O6 | 0.6 | 82.9 |
| 172 | 7.2 | 174899 | 208.0733 | 208.0736 | C11H12O4 | 1.2 | 86.6 |
| 173 | 7.21 | 112017 | 254.1155 | 254.1154 | C13H18O5 | −0.3 | 77.1 |
| 174 | 7.27 | 307888 | 154.0855 | 154.0855 | C6H10N4O | 0.0 | 68.0 |
| 176 | 7.28 | 167901 | 196.1094 | 196.1099 | C11H16O3 | 2.7 | 57.3 |
| 177 | 7.29 | 60478 | 376.1635 | 376.1634 | C19H24N2O6 | −0.2 | 82.1 |
| 178 | 7.31 | 282762 | 292.1057 | 292.1059 | C14H16N2O5 | 0.7 | 77.8 |
| 179 | 7.32 | 231447 | 234.0526 | 234.0528 | C12H10O5 | 0.9 | 86.3 |
| 180 | 7.35 | 62364 | 192.0781 | 192.0786 | C11H12O3 | 2.8 | 84.0 |
| 183 | 7.37 | 105420 | 222.0888 | 222.0892 | C12H14O4 | 1.8 | 82.1 |
| 184 | 7.38 | 88675 | 204.0419 | 204.0423 | C11H8O4 | 1.7 | 47.6 |
| 185 | 7.4 | 279916 | 224.1047 | 224.1049 | C12H16O4 | 0.5 | 86.7 |
| 187 | 7.42 | 16749 | 241.1309 | 241.1314 | C12H19NO4 | 2.1 | 47.0 |
| 189 | 7.42 | 80787 | 234.0889 | 234.0892 | C13H14O4 | 1.2 | 85.3 |
| 190 | 7.43 | 43796 | 336.1681 | 336.1685 | C17H24N2O5 | 1.2 | 81.1 |
| 192 | 7.43 | 90392 | 266.1154 | 266.1154 | C14H18O5 | 0.1 | 83.8 |
| 193 | 7.43 | 195797 | 324.1687 | 324.1685 | C16H24N2O5 | −0.7 | 84.7 |
| 194 | 7.44 | 145053 | 156.0783 | 156.0786 | C8H12O3 | 2.4 | 86.8 |
| 195 | 7.44 | 128759 | 200.1046 | 200.1049 | C10H16O4 | 1.3 | 83.7 |
| 196 | 7.45 | 30103 | 126.0678 | 126.0681 | C7H10O2 | 2.0 | 47.2 |
| 197 | 7.5 | 97725 | 196.0733 | 196.0736 | C10H12O4 | 1.3 | 73.3 |
| 198 | 7.5 | 33873 | 226.0837 | 226.0841 | C11H14O5 | 1.7 | 45.9 |
| 201 | 7.56 | 272457 | 220.0735 | 220.0736 | C12H12O4 | 0.2 | 47.6 |
| 202 | 7.56 | 78441 | 236.1046 | 236.1049 | C13H16O4 | 0.9 | 79.1 |
| 203 | 7.58 | 31965 | 398.2008 | 398.2013 | C14H30N4O9 | 1.3 | 65.2 |
| 206 | 7.59 | 40534 | 364.2145 | 364.2151 | C23H28N2O2 | 1.6 | 73.5 |
| 207 | 7.62 | 213882 | 165.1149 | 165.1154 | C10H15NO | 2.8 | 86.1 |
| 208 | 7.66 | 30040 | 196.0734 | 196.0736 | C10H12O4 | 1.0 | 47.0 |
| 209 | 7.66 | 59702 | 334.1730 | 334.1740 | C14H26N2O7 | 2.9 | 76.2 |
| 210 | 7.66 | 267931 | 276.1204 | 276.1209 | C12H20O7 | 1.7 | 82.7 |
| 212 | 7.67 | 42902 | 422.2052 | 422.2053 | C21H30N2O7 | 0.4 | 79.3 |
| 213 | 7.68 | 81055 | 230.1150 | 230.1154 | C11H18O5 | 2.0 | 81.8 |
| 214 | 7.68 | 122070 | 184.0731 | 184.0736 | C9H12O4 | 2.3 | 85.1 |
| 215 | 7.71 | 30402 | 208.0735 | 208.0736 | C11H12O4 | 0.4 | 47.5 |
| 216 | 7.72 | 17308 | 438.1998 | 438.2002 | C21H30N2O8 | 1.0 | 47.3 |
| 217 | 7.74 | 81345 | 474.1999 | 474.2002 | C24H30N2O8 | 0.7 | 75.2 |
| 218 | 7.74 | 239384 | 416.1476 | 416.1478 | C15H24N6O6S | 0.4 | 87.0 |
| 219 | 7.75 | 83447 | 222.0889 | 222.0892 | C12H14O4 | 1.5 | 82.4 |
| 220 | 7.76 | 61898 | 310.1522 | 310.1529 | C15H22N2O5 | 2.1 | 77.1 |
| 221 | 7.76 | 128048 | 269.1269 | 269.1277 | C14H15N5O | 3.0 | 76.1 |
| 222 | 7.77 | 60768 | 324.1694 | 324.1699 | C17H20N6O | 1.3 | 85.0 |
| 223 | 7.77 | 29042 | 186.1252 | 186.1256 | C10H18O3 | 2.1 | 46.9 |
| 224 | 7.77 | 32943 | 266.1158 | 266.1154 | C14H18O5 | −1.2 | 47.6 |
| 225 | 7.81 | 34827 | 204.1359 | 204.1362 | C10H20O4 | 1.2 | 46.4 |
| 226 | 7.82 | 140557 | 218.0577 | 218.0579 | C12H10O4 | 1.1 | 86.2 |
| 227 | 7.84 | 166902 | 240.0994 | 240.0998 | C12H16O5 | 1.4 | 86.1 |
| 228 | 7.87 | 22918 | 264.0998 | 264.0998 | C14H16O5 | −0.3 | 47.3 |
| 229 | 7.88 | 445734 | 252.0998 | 252.0998 | C13H16O5 | −0.1 | 47.3 |
| 230 | 7.89 | 555848 | 206.0578 | 206.0579 | C11H10O4 | 0.6 | 76.6 |
| 231 | 7.89 | 191377 | 310.1529 | 310.1529 | C15H22N2O5 | 0.0 | 98.8 |
| 232 | 7.9 | 262182 | 318.1107 | 318.1103 | C17H18O6 | −1.2 | 82.9 |
| 233 | 7.9 | 837172 | 376.1632 | 376.1634 | C19H24N2O6 | 0.6 | 83.4 |
| 235 | 7.93 | 56215 | 180.0784 | 180.0786 | C10H12O3 | 1.3 | 80.3 |
| 236 | 7.94 | 87309 | 190.0629 | 190.0630 | C11H10O3 | 0.7 | 85.7 |
| 238 | 7.97 | 103809 | 238.1205 | 238.1205 | C13H18O4 | 0.0 | 83.8 |
| 239 | 7.97 | 61786 | 378.1783 | 378.1791 | C19H26N2O6 | 2.1 | 80.0 |
| 240 | 7.99 | 38187 | 308.1264 | 308.1267 | C9H20N6O4S | 0.8 | 46.7 |
| 241 | 7.99 | 46360 | 234.0890 | 234.0892 | C13H14O4 | 0.9 | 70.5 |
| 242 | 7.99 | 41842 | 402.1681 | 402.1692 | C23H22N4O3 | 2.7 | 76.1 |
| 243 | 8 | 350002 | 224.0867 | 224.0871 | C12H16O2S | 1.9 | 53.4 |
| 244 | 8 | 79232 | 303.1682 | 303.1682 | C14H25NO6 | 0.1 | 82.3 |
| 246 | 8.01 | 77219 | 344.1946 | 344.1947 | C16H28N2O6 | 0.3 | 85.0 |
| 247 | 8.01 | 138286 | 460.2211 | 460.2210 | C24H32N2O7 | −0.4 | 80.9 |
| 248 | 8.04 | 53264 | 210.0891 | 210.0892 | C11H14O4 | 0.4 | 75.1 |
| 249 | 8.04 | 37667 | 214.1205 | 214.1205 | C11H18O4 | 0.0 | 47.6 |
| 250 | 8.04 | 68132 | 202.1203 | 202.1205 | C10H18O4 | 1.0 | 47.3 |
| 251 | 8.05 | 279070 | 340.1634 | 340.1634 | C16H24N2O6 | 0.0 | 88.4 |
| 252 | 8.05 | 607167 | 299.1374 | 299.1369 | C14H21NO6 | −1.7 | 96.4 |
| 253 | 8.06 | 39365 | 282.1108 | 282.1110 | C7H18N6O4S | 0.8 | 46.2 |
| 254 | 8.06 | 84081 | 268.1313 | 268.1311 | C14H20O5 | −0.7 | 66.4 |
| 255 | 8.06 | 34815 | 422.2051 | 422.2053 | C21H30N2O7 | 0.6 | 80.5 |
| 256 | 8.09 | 87464 | 254.1155 | 254.1154 | C13H18O5 | −0.2 | 84.8 |
| 257 | 8.09 | 40292 | 274.0843 | 274.0841 | C15H14O5 | −0.8 | 76.3 |
| 258 | 8.1 | 53826 | 320.1346 | 320.1347 | C20H20N2S | 0.4 | 75.5 |
| 259 | 8.1 | 36107 | 262.0847 | 262.0848 | C7H14N6O3S | 0.5 | 47.2 |
| 260 | 8.13 | 27528 | 246.1465 | 246.1467 | C12H22O5 | 1.1 | 47.2 |
| 262 | 8.15 | 73051 | 182.0943 | 182.0943 | C10H14O3 | −0.3 | 46.9 |
| 264 | 8.16 | 71030 | 267.1134 | 267.1140 | C10H21NO5S | 2.4 | 45.4 |
| 265 | 8.17 | 20859 | 264.1000 | 264.0998 | C14H16O5 | −0.9 | 47.4 |
| 270 | 8.2 | 137097 | 210.0895 | 210.0892 | C11H14O4 | −1.2 | 85.0 |
| 271 | 8.21 | 41570 | 274.0847 | 274.0855 | C16H10N4O | 2.7 | 79.4 |
| 272 | 8.22 | 68468 | 198.0893 | 198.0892 | C10H14O4 | −0.5 | 47.3 |
| 273 | 8.22 | 35701 | 254.1157 | 254.1161 | C6H18N6O3S | 1.6 | 46.5 |
| 274 | 8.23 | 35243 | 248.1052 | 248.1049 | C14H16O4 | −1.3 | 65.8 |
| 276 | 8.23 | 20359 | 334.1436 | 334.1430 | C19H18N4O2 | −1.8 | 47.6 |
| 277 | 8.24 | 50688 | 420.1903 | 420.1910 | C22H24N6O3 | 1.7 | 79.9 |
| 278 | 8.24 | 48903 | 284.1748 | 284.1749 | C15H20N6 | 0.4 | 47.5 |
| 279 | 8.24 | 44692 | 346.1525 | 346.1529 | C18H22N2O5 | 1.2 | 76.7 |
| 280 | 8.24 | 29775 | 458.2048 | 458.2035 | C36H26 | −3.0 | 71.4 |
| 281 | 8.24 | 15663 | 362.1383 | 362.1381 | C13H26N6S3 | −0.5 | 47.6 |
| 282 | 8.27 | 49146 | 262.0845 | 262.0841 | C14H14O5 | −1.4 | 78.9 |
| 283 | 8.27 | 129134 | 320.1369 | 320.1372 | C16H20N2O5 | 0.9 | 84.9 |
| 284 | 8.27 | 298798 | 166.0629 | 166.0630 | C9H10O3 | 0.5 | 84.1 |
| 285 | 8.28 | 60890 | 354.1789 | 354.1791 | C17H26N2O6 | 0.5 | 84.6 |
| 286 | 8.28 | 44217 | 338.1840 | 338.1842 | C17H26N2O5 | 0.5 | 76.4 |
| 288 | 8.29 | 30555 | 250.0839 | 250.0841 | C13H14O5 | 0.9 | 47.6 |
| 290 | 8.31 | 118093 | 288.1000 | 288.0998 | C16H16O5 | −0.7 | 80.8 |
| 291 | 8.32 | 22374 | 278.0797 | 278.0797 | C7H14N6O4S | 0.0 | 47.0 |
| 292 | 8.33 | 53356 | 266.1155 | 266.1154 | C14H18O5 | −0.3 | 62.1 |
| 293 | 8.35 | 128557 | 448.1854 | 448.1854 | C23H32N2O3S2 | 0.0 | 83.3 |
| 294 | 8.35 | 24715 | 390.1324 | 390.1323 | C21H26O3S2 | −0.1 | 47.5 |
| 295 | 8.36 | 520623 | 176.0470 | 176.0473 | C10H8O3 | 2.0 | 68.2 |
| 296 | 8.36 | 106427 | 318.1105 | 318.1103 | C17H18O6 | −0.4 | 84.2 |
| 297 | 8.37 | 67809 | 406.1746 | 406.1753 | C21H22N6O3 | 1.9 | 71.0 |
| 298 | 8.37 | 413127 | 348.1215 | 348.1209 | C18H20O7 | −1.7 | 87.5 |
| 299 | 8.41 | 137899 | 194.0941 | 194.0943 | C11H14O3 | 0.9 | 86.0 |
| 300 | 8.41 | 269699 | 222.0891 | 222.0892 | C12H14O4 | 0.4 | 70.0 |
| 301 | 8.43 | 132981 | 188.1408 | 188.1412 | C10H20O3 | 2.6 | 47.3 |
| 303 | 8.44 | 86910 | 240.1354 | 240.1362 | C13H20O4 | 3.0 | 83.5 |
| 304 | 8.45 | 85973 | 504.2467 | 504.2472 | C26H36N2O8 | 1.0 | 78.6 |
| 305 | 8.45 | 31782 | 458.2047 | 458.2035 | C36H26 | −2.7 | 72.8 |
| 306 | 8.45 | 58518 | 248.1045 | 248.1049 | C14H16O4 | 1.7 | 78.6 |
| 307 | 8.45 | 69609 | 288.0992 | 288.0998 | C16H16O5 | 1.8 | 82.0 |
| 308 | 8.48 | 251454 | 226.0841 | 226.0841 | C11H14O5 | 0.2 | 81.9 |
| 309 | 8.48 | 11209 | 432.1870 | 432.1865 | C18H32N4O4S2 | −1.2 | 47.6 |
| 312 | 8.51 | 155396 | 238.1209 | 238.1205 | C13H18O4 | −1.7 | 85.4 |
| 313 | 8.51 | 48488 | 320.1356 | 320.1347 | C20H20N2S | −2.6 | 72.0 |
| 314 | 8.51 | 33514 | 262.0847 | 262.0848 | C7H14N6O3S | 0.5 | 45.3 |
| 315 | 8.52 | 33022 | 286.0847 | 286.0841 | C16H14O5 | −2.1 | 47.6 |
| 316 | 8.52 | 52482 | 344.1331 | 344.1332 | C13H20N4O7 | 0.2 | 71.3 |
| 318 | 8.54 | 32361 | 568.2414 | 568.2421 | C30H36N2O9 | 1.2 | 73.5 |
| 319 | 8.55 | 35134 | 502.2310 | 502.2315 | C26H34N2O8 | 1.0 | 73.5 |
| 320 | 8.55 | 13759 | 338.1374 | 338.1366 | C17H22O7 | −2.5 | 47.6 |
| 324 | 8.57 | 60165 | 362.1371 | 362.1379 | C20H18N4O3 | 2.3 | 80.6 |
| 325 | 8.57 | 11738 | 490.2211 | 490.2203 | C26H34O9 | −1.7 | 47.3 |
| 327 | 8.6 | 33004 | 406.1744 | 406.1753 | C21H22N6O3 | 2.4 | 76.3 |
| 330 | 8.65 | 108312 | 220.1101 | 220.1099 | C13H16O3 | −0.7 | 47.6 |
| 331 | 8.66 | 29225 | 152.0835 | 152.0837 | C9H12O2 | 1.7 | 47.2 |
| 332 | 8.67 | 85178 | 224.1046 | 224.1049 | C12H16O4 | 1.1 | 73.4 |
| 333 | 8.67 | 626807 | 216.1356 | 216.1362 | C11H20O4 | 2.5 | 78.6 |
| 334 | 8.7 | 50955 | 308.1703 | 308.1696 | C11H24N4O6 | −2.2 | 57.1 |
| 335 | 8.72 | 56253 | 272.1618 | 272.1624 | C14H24O5 | 2.0 | 79.6 |
| 336 | 8.74 | 172488 | 234.0887 | 234.0892 | C13H14O4 | 2.1 | 85.9 |
| 337 | 8.75 | 57396 | 338.1836 | 338.1842 | C17H26N2O5 | 1.6 | 82.7 |
| 338 | 8.75 | 51503 | 254.1512 | 254.1518 | C14H22O4 | 2.2 | 74.1 |
| 339 | 8.76 | 38516 | 502.2313 | 502.2315 | C26H34N2O8 | 0.3 | 74.8 |
| 340 | 8.76 | 32572 | 444.1799 | 444.1798 | C25H24N4O4 | −0.3 | 74.1 |
| 341 | 8.77 | 50814 | 514.1959 | 514.1965 | C27H26N6O5 | 1.1 | 77.9 |
| 342 | 8.8 | 30040 | 518.2258 | 518.2246 | C38H30O2 | −2.4 | 73.3 |
| 344 | 8.82 | 48533 | 402.1788 | 402.1791 | C21H26N2O6 | 0.7 | 79.8 |
| 345 | 8.82 | 21607 | 320.1734 | 320.1736 | C17H24N2O4 | 0.6 | 46.4 |
| 346 | 8.82 | 32764 | 346.1422 | 346.1423 | C12H22N6O4S | 0.3 | 47.6 |
| 347 | 8.83 | 157016 | 234.0891 | 234.0892 | C13H14O4 | 0.3 | 47.3 |
| 350 | 8.87 | 53536 | 154.0995 | 154.0994 | C9H14O2 | −0.8 | 47.6 |
| 351 | 8.87 | 110608 | 214.1566 | 214.1569 | C12H22O3 | 1.3 | 86.9 |
| 352 | 8.89 | 211908 | 200.1409 | 200.1412 | C11H20O3 | 1.6 | 86.8 |
| 353 | 8.93 | 78082 | 276.1360 | 276.1362 | C16H20O4 | 0.6 | 83.4 |
| 354 | 8.94 | 53539 | 476.2162 | 476.2172 | C25H28N6O4 | 2.1 | 78.1 |
| 355 | 8.94 | 78313 | 384.1578 | 384.1586 | C23H20N4O2 | 2.2 | 82.1 |
| 356 | 8.94 | 19203 | 418.1655 | 418.1643 | C16H30N6OS3 | −2.7 | 47.6 |
| 357 | 8.94 | 314680 | 488.2523 | 488.2523 | C26H36N2O7 | −0.1 | 95.7 |
| 358 | 8.94 | 62748 | 202.1565 | 202.1569 | C11H22O3 | 2.1 | 47.4 |
| 360 | 8.98 | 114312 | 430.2012 | 430.2005 | C25H26N4O3 | −1.7 | 88.9 |
| 362 | 9.03 | 63568 | 372.1577 | 372.1573 | C21H24O6 | −1.1 | 82.2 |
| 363 | 9.06 | 49596 | 236.1049 | 236.1049 | C13H16O4 | −0.3 | 47.5 |
| 365 | 9.07 | 32191 | 435.1903 | 435.1907 | C23H25N5O4 | 0.9 | 76.6 |
| 366 | 9.07 | 133368 | 476.2162 | 476.2159 | C24H32N2O8 | −0.8 | 97.1 |
| 367 | 9.11 | 135166 | 430.2020 | 430.2025 | C21H34O7S | 1.3 | 93.7 |
| 369 | 9.14 | 23340 | 230.1514 | 230.1518 | C12H22O4 | 1.8 | 46.8 |
| 370 | 9.15 | 46146 | 400.1882 | 400.1886 | C23H28O6 | 1.0 | 77.5 |
| 371 | 9.19 | 48238 | 214.1565 | 214.1569 | C12H22O3 | 1.7 | 47.0 |
| 372 | 9.25 | 51996 | 274.1781 | 274.1780 | C14H26O5 | −0.3 | 47.6 |
| 373 | 9.26 | 80933 | 198.1616 | 198.1620 | C12H22O2 | 1.8 | 83.3 |
| 374 | 9.3 | 30748 | 532.2773 | 532.2785 | C28H40N2O8 | 2.1 | 73.9 |
| 375 | 9.3 | 33591 | 462.2344 | 462.2341 | C28H34N2O2S | −0.7 | 68.3 |
| 377 | 9.33 | 61953 | 430.2088 | 430.2079 | C27H30N2OS | −2.2 | 69.7 |
| 379 | 9.35 | 33176 | 520.2411 | 520.2421 | C26H36N2O9 | 1.9 | 77.5 |
| 381 | 9.41 | 27133 | 594.2570 | 594.2577 | C32H38N2O9 | 1.2 | 71.3 |
| 382 | 9.41 | 40414 | 442.2099 | 442.2104 | C24H30N2O6 | 1.1 | 75.8 |
| 383 | 9.44 | 43958 | 596.2729 | 596.2734 | C32H40N2O9 | 0.8 | 74.4 |
| 384 | 9.47 | 28859 | 386.1729 | 386.1723 | C14H30N2O8S | −1.6 | 45.2 |
| 385 | 9.47 | 90502 | 444.2258 | 444.2260 | C24H32N2O6 | 0.5 | 81.6 |
| 386 | 9.54 | 84204 | 336.2048 | 336.2049 | C18H28N2O4 | 0.3 | 85.2 |
| 387 | 9.65 | 50092 | 300.1937 | 300.1937 | C16H28O5 | −0.1 | 47.6 |
| 388 | 9.66 | 91069 | 358.2468 | 358.2468 | C18H34N2O5 | −0.2 | 84.9 |
| 389 | 9.66 | 106582 | 317.2203 | 317.2202 | C16H31NO5 | −0.1 | 82.0 |
| 390 | 9.67 | 426025 | 244.1675 | 244.1675 | C13H24O4 | −0.1 | 83.7 |
| 392 | 9.87 | 95939 | 350.2206 | 350.2206 | C19H30N2O4 | −0.1 | 85.0 |
| 393 | 9.96 | 19195 | 258.1831 | 258.1831 | C14H26O4 | 0.0 | 47.6 |
| 394 | 10.14 | 220483 | 278.1518 | 278.1518 | C16H22O4 | 0.1 | 86.1 |
| 395 | 10.14 | 65839 | 204.0782 | 204.0786 | C12H12O3 | 2.0 | 85.3 |
| 396 | 10.15 | 43349 | 283.2146 | 283.2147 | C16H29NO3 | 0.7 | 74.3 |
| 397 | 10.32 | 36335 | 302.2246 | 302.2246 | C20H30O2 | 0.0 | 83.2 |
| 398 | 10.46 | 90642 | 304.2403 | 304.2402 | C20H32O2 | −0.2 | 85.0 |

TABLE 11
Suggested Compounds in FILTRATE from LC/QTOF Analysis

| # Formula | Mass | Cpd |
|---|---|---|
| C6H12O6 | 180.06339 | Glucose |
| C8H8O3 | 152.04734 | Vanillin |
| C5H10O5 | 150.05282 | Arabinose |
| C6H12O6 | 180.06339 | Mannose |
| C5H10O5 | 150.05282 | Xylose |
| C6H12O6 | 180.06339 | Galactose |
| C5H4O2 | 96.02113 | Furfural |
| C6H6O3 | 126.03169 | 5-Hydroxymethylfurfural |
| C2H4O2 | 60.02113 | Acetic Acid |
| C2H6O | 46.04186 | Ethanol |
| C5H8O3 | 116.04734 | Levulinic Acid |
| C3H6O3 | 90.03169 | Lactic Acid |
| C7H12O3 | 144.07864 | Ethyl Levulinate |
| CH2O2 | 46.00548 | Formic Acid |
| C4H6O4 | 118.02661 | Succinic Acid |
| C6H6O2 | 110.03678 | Methyl Furfural (Furfural Derivatives) |
| C2H4O3 | 76.01604 | Hydroxy Acids (Glycolic Acid) |
| C6H12O7 | 196.05830 | D-Gluconic Acid |
| C12H22O12 | 358.11113 | Cellobionic Acid |
| C5H10O6 | 166.04774 | D-Arabinonic Acid |
| C4H8O5 | 136.03717 | D-Erythronic Acid |
| C2H2O3 | 74.00039 | Glyoxylic Acid |
| C6H10O7 | 194.04265 | D-Glucuronic Acid |
| C2H4O3 | 76.01604 | Glycolic Acid |
| C3H6O3 | 90.03169 | 2-Hydroxypropionic |
| C3H6O4 | 106.02661 | Glyceric Acid |
| C4H4O4 | 116.01096 | 3,4-Dihydroxybutyric Acid |
| C6H10O8 | 210.03757 | Glucaric Acid |
| C5H12O5 | 152.06847 | Xylitol (Other Sugar Alcohols) |
| C9H10O4 | 182.05791 | Syringaldehyde |
| C7H6O3 | 138.03169 | p-Hydroxybenzoic Acid |
| C6H6O | 94.04186 | Phenol |
| C8H10O3 | 154.06299 | 2,6-Dimethoxy Phenol (Syringol) |
| C10H12O2 | 164.08373 | Isoeugenol (2-methoxy-4-propenyl) phenol |
| C7H8O2 | 124.05243 | 2-Methoxy phenol |
| C18H36O2 | 284.27153 | Ethyl ester of hexadecanoic acid |
| C6H12O3 | 132.07864 | Ethyl Ester 2-Hydroxy butanoic acid |
| C20H40O2 | 312.30283 | Ethyl ester octadecanoic acid |
| C19H32O2 | 292.24023 | Methyl ester 9,12,15-Octadecatrienoic |
| | | acid |
| C7H12O4 | 160.07356 | Ethyl Methyl Ester Butanedioic acid |
| C8H14O4 | 174.08921 | Diethyl Ester Butandioic acid (Diethyl |
| | | Succinate) |
| C20H38O2 | 310.28718 | Ethyl Oleate |
| C7H8O3 | 140.04734 | Ethyl Ester 2-Furancarboxylic acid |
| C17H34O2 | 270.25588 | Methyl Ester Hexadecanoic acid |
| C6H10O5 | 162.05282 | Diethyl Ester Hydroxy butanedioic |
| C6H8O2 | 112.05243 | 2-Hydroxy-3-methyl-2-cyclopenten-1-one |
| C8H6O3Cl2 | 219.96940 | ISTD - Dicamba |
| C9H9O3Cl | 200.02402 | ISTD - MCPA |
| C9H8O3Cl2 | 233.98505 | ISTD - 2,4-DP |
| C10H11O3Cl | 214.03967 | ISTD - MCPP |
| C11H13O3Cl | 228.05532 | ISTD - MCPB |
| C9H10N4O2S2 | 270.02452 | ISTD - Sulfamethizole |
| C12H14N4O2S | 278.08375 | ISTD - Sulfamethazine |
| C10H9N4O2SCl | 284.01347 | ISTD - Sulfachloropyridazine |
| C12H14N4O4S | 310.07358 | ISTD - Sulfadimethoxine |
| C5H10O3 | 118.06299 | Ethyl Lactate |
| C6H6O2 | 110.03678 | 5-Methyl-2-furancarboxaldehyde |
| C11H14O3 | 194.09429 | 2,6-Dimethoxy-4-(2-propenyl)-phenol |
| C6H10O5 | 162.05282 | 1,6-anhydroglucose |
| H2O4S | 97.96738 | Sulphuric acid |

TABLE 12
Average molecular masses, polydispersity and glass transition points
of ASPEN MACs

| | Mn | Mw | Mz | | Tg |
|---|---|---|---|---|---|
| Aromatic Mixes (MACs) | g/moL | | | D | ° C. |
| MAC II | 601 | 1331 | 2381 | 2.22 | 69.14 |
| MAC II | 597 | 1326 | 2377 | 2.22 | 67.51 |
| MAC I | 335 | 2855 | 5859 | 8.52 | N/A |
| MAC I | 351 | 2911 | 5953 | 8.28 | N/A |
| ACETONE-INSOLUBLES | 581 | 2787 | 5733 | 4.8 | N/A |
| MAC I | | | | | |
| ACETONE-INSOLUBLES | 582 | 2805 | 5794 | 4.82 | N/A |
| MAC I | | | | | |
| ACETONE-SOLUBLES | 281 | 2643 | 5561 | 9.38 | 102.85 |
| MAC I | | | | | |
| ACETONE-SOLUBLES | 281 | 2644 | 5562 | 9.37 | N/A |
| MAC I | | | | | |

### Synthesis of MAC-Phenol-Formaldehyde (LPF) Resins for Wood Composites

LPF Resins were synthesized from a 40/60 MAC/Phenol mixture, and at a Phenol:Formaldehyde molar ratio of 1:2.55.

Reagents & equipment used for the synthesis method:
12.76 g 50% NaOH solution (Fisher Scientific, CAS 1310-73-2, Cat#SS410-4)
42.4 g 37% Formaldehyde solution (Fisher Scientific, CAS 50-00-0, Cat#F79-4)
19.28 g Phenol (Fisher Scientific, CAS 108-95-2, Cat#A91I-212)
32.71 g Nanopure water (18.2 MΩ*cm or better)
12.85 g MACs produced by Lignol Innovations, Ltd., Burnaby, BC, Canada
250 ml 3-neck round bottom flasks
Small condenser
Corning brand thermocouple
Rubber stoppers
Rubber stoppers with a hole punched in center to accept a thermocouple
Teflon covered magnetic stir bar
Hot-stirring plates
Medium crystallizing dish that fit the 250 ml round bottom flask
1 big crystallizing dish
Small plastic funnel
100 ml beaker
1 small glass funnel
3-50 ml volumetric flasks with glass stoppers
2 pieces of connecting tubing for the condensers
2 clamps for the flasks and condensers
Metal stand
Weighing dish
Portable Viscolite viscometer from Hydramotion Ltd. (York, England)

The reagents were weighed and synthesis resin reactors were set-up by connecting the condensers with the tubing in series, clamping the round bottom flask on top of the crystallizing dish, sitting on a hot-stirring plate. Thermocouples were inserted through rubber stoppers and placed in the centre joint of the flask. The clamped condenser was placed in one of the side joints of the flask. A magnetic stir bar was placed in the flask. On another hot-stirring plate a big crystallizing dish was placed containing the jar with solid phenol. Sufficient hot water was added to the crystallizing dish to cover the level of solid phenol in the jar. The water was heated to approximately 70-80° C. in order to melt the phenol.

While the phenol was melting, 100 mL beaker and a small glass funnel were heated in a 105° C. oven. Hot water was added in the crystallizing dishes containing the flasks, and the hotplate temperature set to 55° C. When the phenol was molten and the hotplate had achieved 55° C., the phenol was removed from the hot water bath. 19.3 g of molten phenol was added to the hot, 100 mL beaker. Liquid phenol was poured through the hot glass funnel into the round bottom flask.

Over 10-15 minutes 12.85 g of MAC was added in small amounts to the flasks through a small plastic funnel. Stirring speed was 300 rpm and as the mixture viscosity increased the stirring speed was gradually be increased to 340 rpm.

The stirring speed was reduced to 300 rpm. 32.71 g of deionized water and 12.76 g 50% NaOH solution was poured into the flask. The temperature may increase due to the exothermic nature of the reaction. Once the reaction temperature was stabilized at 55° C. the mixture was left to stand for 10 additional minutes then 42.4 g 37% formaldehyde solution was slowly added. The temperature was increased to 70° C. and left for it to stabilize (approx. 10 mins). Once the temperature had stabilized, the hotplate was set to 75° C. After the reaction achieved 75° C. it was held for 3 hours. The hotplate maintained the reaction temperature throughout the experiment. The water level was monitored and hot water added as necessary. The level was kept above the resin level within the flask.

After 3 h at 75° C., the reaction temperature was increased to 80° C. and, after stabilization, maintained for 2.5 hours. The level of water in crystallizing dishes was monitored to ensure it did not drop below that of the resin in the flasks.

A few minutes before the 2 h 30 minutes are done, prepare 2 big crystallizing dishes with cold water. After 2 h30 min at 80° C., the hotplate was adjusted to 35° C., and the flask with the condenser raised above the crystallizing dish. The dish with hot water was removed and poured away. A big crystallizing dish with cold water was placed on the hot plate and the flask with the condenser lowered in the cold water bath. More cold water was poured in until the flask is immersed up to the joints' level in cold water. The flask was kept immersed, under continuous stirring and in cold water, until the temperature in the reaction mixture stabilized at 35° C. The reaction was then removed from the cold water bath. The bond strength (also called “shear strength”) of MAC-PF resins was tested by the ABES method (Wescott, J. M., Birkeland, M. J., Traska, A. E., New Method for Rapid Testing of Bond Strength for Wood Adhesives, Heartland Resource Technologies Waunakee, Wis., U.S.A. and Frihart, C. R. and Dally, B. N., USDA Forest Service, Forest Products Laboratory, Madison, Wis., U.S.A., Proceedings 30^{th} Annual Meeting of The Adhesion Society, Inc., Feb. 18-21, 2007, Tampa Bay, Fla., USA) under the following conditions: sliced aspen strands: 117 mm×20 mm×0.8 mm (conditioned at 50% HR & 20° C.), bonding area: 20 mm×5 mm, press temperature: 150° C., press pressure: 2 MPa, press time: 90 seconds. Ten replicates for each resin sample were run. The average bond strength in MPa of ten replicates was then normalized dividing by the grams loaded resin per square centimeter of bonding area to yield the Normalized Bond Strength (NBS) or normalized shear strength.

TABLE 13
Bond strength performance of the MACs PF Resins
(40% phenol replacement) compared to Alcell ®-Lignin PF_Resins

| | Normalized Bond Strength |
|---|---|
| | at 150° C.* |
| | MPa * cm²/g resin |
| MAC-I PF Resin | 3,700 ± 273 |
| MAC-II PF Resin | 3,108 ± 355 |
| ACETONE-SOLUBLE MAC-I PF | 3,229 ± 235 |
| Resin | |
| Alcell ®-Lignin PF_Resin | 3,079 ± 244 |

*Average of 10 replicates at 40% phenol replacement level

1-27. (canceled)

28. A process of producing levulinic acid, said process comprising:
a. placing a lignocellulosic biomass in an extraction vessel;
b. mixing the lignocellulosic material with an organic solvent to form an extraction mixture;
c. subjecting the mixture to an elevated temperature and pressure;
d. maintaining the elevated temperature and pressure for a period of time; and
e. recovering levulinic acid from the spent solvent;
wherein the stoichiometric yield of levulinic acid is about 20% or greater.

29. The process of claim 28, wherein the stoichiometric yield of levulinic acid is about 40% or greater.

30. The process of claim 28, wherein the stoichiometric yield of levulinic acid is 50% or greater, about 60% or greater.

31. The process of claim 28, wherein the ratio of solvent to biomass is from about 7:1 to about 4:1.

32. The process of claim 28, wherein the temperature is about 180° C. or greater.

33. The process of claim 28, wherein the pressure is about 1 bar or greater.

34. The process of claim 28, wherein the pressure is about 25 bar or greater.

35. The process of claim 28, wherein the pH of the extraction mixture is 0.5 or greater.

36. The process of claim 28, wherein the elevated temperature is applied to the extraction mixture for 30 minutes of longer.

37. The process of claim 28, wherein the levulinic acid is further converted into ethyl levulinate.

38. The process of claim 28, the levulinic acid is further converted into ethyl levulinate by exposing the levulinic acid to an esterase suitable for converting levulinic acid and ethanol to ethyl levulinate.

39. The process of claim 38, wherein the esterase is immobilized.

40. An extraction process comprising:
a. placing a lignocellulosic biomass in an extraction vessel;
b. mixing the lignocellulosic material with an organic solvent to form an extraction mixture;
c. subjecting the mixture to a temperature and pressure such that a slurry is formed, wherein the slurry has a viscosity of 1500 cps or less;
d. maintaining the temperature and pressure for a period of time;
e. recovering aromatic compounds from the spent solvent;
wherein the yield of aromatic compounds is 35% or greater of loaded dry weight biomass.

41. The process of claim 40, wherein the ratio of solvent to biomass is from about 7:1 to about 4:1.

42. The process of claim 40, wherein the temperature is 180° C. or greater.

43. The process of claim 40, wherein the pressure is 1 bar or greater.

44. The process of claim 40, wherein the pressure is 25 bar or greater.

45. The process of claim 40, wherein the pH of the extraction mixture is 0.5 or greater.

46. The process of claim 40, wherein the elevated temperature is applied to the extraction mixture for 30 minutes of longer.

47. An extraction process comprising:
a. placing a lignocellulosic biomass in an extraction vessel;
b. mixing the lignocellulosic material with an organic solvent to form an extraction mixture;
c. subjecting the mixture to a temperature and pressure such that a slurry is formed, wherein the slurry has a viscosity of 1500 cps or less;
d. maintaining the elevated temperature and pressure for a period of time;
e. recovering process-derived aromatic compounds from the spent solvent;
wherein the yield of aromatic compounds is at least about 90% of the theoretical maximum yield of lignin from the biomass.

48. The extraction process of claim 47 wherein the yield of aromatic compounds is at least about 100%, about 105%, about 110%, of the theorectical maximum yield of lignin.
